(19) United States
(12) Patent Application Publication
(10) Pub. No.: US 2021/0321068 A1
(43) Pub. Date: Oct. 14, 2021

(54) Systems and Methods for Remote Image Projection

(71) Applicant: Optical Systems Engineering Group, LLC, Jacksonville, FL (US)

(72) Inventors: James W. Haywood, Fleming Island, FL (US); James Daniel Riall, St. Johns, FL (US); James E. Michalski, St. Johns, FL (US); Russell T. Spaulding, St. Johns, FL (US)

(21) Appl. No.: 17/225,815

(22) Filed: Apr. 8, 2021

Related U.S. Application Data
(60) Provisional application No. 63/007,434, filed on Apr. 9, 2020.

(51) Int. Cl. H04N 9/31

(52) U.S. Cl. CPC H04N 9/3185; H04N 9/315

(57) ABSTRACT

The present disclosure provides for a system and method for remote image projection. The system may comprise a compact optical system to provide remote projections of images. The system may comprise an image correction subsystem, an image motion and positioning subsystem, an image relay and deflection subsystem, a source image, a warped image, a remotely projected image. The method may comprise processing the source image with a dewarping algorithm. The image correction subsystem may comprise a source image, a dewarping algorithm. When the system comprises an intermediate image plane, the warped image may be configured to project on the target projection surface upon arrival to the intermediate image plane. The image relay and deflection subsystem may comprise passive mechanical relay optics to refine the remotely projected image and direct the remotely projected image to the target projection surface.

### CROSS REFERENCE SECTION

This application claims priority to and the full benefit of U.S. Provisional Patent Application Ser. No. 63/007,434, filed Apr. 9, 2020, and titled “Remote Image Projection System”, the entire contents of which are incorporated in this application by reference.

### BACKGROUND

Projectors and projection systems are commonplace in both commercial and home environments. A projector is an optical device that may display an image, picture, or animation onto a surface, typically a projection screen. Types of projectors may vary depending on the input to display or how the projector may display

Projectors and projection systems are commonplace in both commercial and home environments. A projector is an optical device that may display an image, picture, or animation onto a surface, typically a projection screen. Types of projectors may vary depending on the input to display or how the projector may display said input. For example, some projectors create an image by shining a light through a transparent lens, though some can project an image directly with lasers. This process changed as projection embraced digital media.

Typically, a micro-mirror array is illuminated, typically by red, green, and blue light emitting diodes (LEDs). The resulting image is projected by a lens configuration onto a flat, or gently curved, fixed surface or “screen” for viewing. The curvature of current “non-flat” projection screens are limited by the depth of focus of the projection unit optical lens assembly. The projection unit is a combination of electronic and power circuitry and a glass or plastic lens assembly.

Available projectors are designed to operate at near normal incidence to a flat, or gently curved, screen surface. Attempting to project to a surface with curvatures which exceed the system depth of focus at the edge of the image or any angle causes both distortion and de-focus issues for the images being displayed. Small angles or irregularities off of this surface produces a distortion, referred to as a “keystone effect,” where the top of the image is a different size than the bottom. Within a range of small or shallow angles, projectors have hardware and software that removes the keystone effect. The quality of the projected image is reduced by defocus as the projection screen curvature increases.

However, at larger oblique angles, such as 60 degrees from the surface normal, the anti-keystone adjustments are not available, so the images are distorted or warped. Significantly non-planar image surfaces, such as the inside of an MM cylindrical bore, further contribute to image distortion and introduce significant focus errors across the image. In such applications, the image must be re-positioned with little to no change in image size, quality, and brightness. For instance, an Mill patient may be located at several locations within the equipment bore. It is desirable for the projected image to always be the same size and quality as the patient moves through the bore and the image is relocated to stay in the patient's view.

These commercial projection systems are not suitable for remote image projection where the projector electronics are located in an environment where it interferes with the electronics' functionality or where the electronics may interfere with the surrounding environment such as the case of a medical diagnostic facility utilizing high magnetic fields. There is a continuing issue for properly displaying a large image within display areas with large angles or curves with a small optical system. Further, there are potential issues displaying necessary images in small, controlled spaces. These environments currently require the projector to be located at some distance from the viewing screen, creating uncontrolled image size and brightness.

### SUMMARY OF THE DISCLOSURE

What is needed is a system and method for remote image projection, particularly a compact optical system to provide remote projections of images. In some embodiments, these images may be static, animated, live, and then projected onto a non-flat surface, such as the inner surface of a cylinder, at oblique angles. The system also has the capability for re-positioning the projected image with little or no change in image size, quality, or brightness. The resulting optical system may work within whatever angle is causing the distortion while miniaturizing and magnifying relevant imagery. For example, within an Mill cylindrical bore, the optical system has to account for a mobile machine while projecting large images without distortion.

The present disclosure provides for a system and method for remote image projection. The system may comprise a compact optical system to provide remote projections of images. The system may comprise an image correction subsystem, an image motion and positioning subsystem, an image relay and deflection subsystem, a source image, a warped image, a remotely projected image. The method may comprise processing the source image with a dewarping algorithm. The image correction subsystem may comprise a source image, a dewarping algorithm.

When the system comprises an intermediate image plane, the warped image may be configured to project on the target projection surface upon arrival to the intermediate image plane. The image relay and deflection subsystem may comprise passive mechanical relay optics to refine the remotely projected image and direct the remotely projected image to the target projection surface. The dewarping algorithm may utilize machine learning to optimize the projection of the warped image to resemble the source image.

One general aspect includes a system for remote image projection. The system may comprise an image correction subsystem that may comprise a dewarping algorithm, where the image correction subsystem may be configured to receive a source image, and where application of the source image to the dewarping algorithm transmits a warped image based on predefined parameters of a target projection surface. A projection subsystem may comprise a light engine in logical communication with the image correction subsystem, where the light engine transmits a warped projection from the warped image, a projection optics, where the warped projection may be formed to a predetermined size, and an intermediate image may be created at a remote distance from the projection subsystem.

In some embodiments, the system may comprise an image relay and deflection subsystem configured to receive the warped projection from the projection subsystem, where the warped projection may be transmitted through an intermediate image plane. In some implementations, the image relay and deflection subsystem may comprise a relay optics, where the projection may be focused and scaled to a predefined size, and a first fold mirror group may be configured to adjust an angle of the warped projection and project the warped projection onto the target projection surface, where projection of the warped projection on the target projection surface creates a remotely projected image.

In some embodiments, the system where at least a portion of one or both the projection subsystem or the image relay and deflection system may be movable, and the intermediate image plane position may be variable. In some implementations, the light engine may be adjustable to the intermediate image plane. In some aspects, the image relay and deflection system may comprise materials benign to operation in a high strength magnetic field.

In some embodiments, the projection subsystem may be vertically oriented, and the warped projection may be projected horizontally with use of a second fold mirror group to the image relay and deflection subsystem. The target projection surface may be nonplanar. In some implementations, the image correction subsystem may be configured to generate the dewarping algorithm. Implementations of the described techniques may include hardware, a method or process, or computer software on a computer-accessible medium.

In some embodiments, there may be a method for projecting remote images. In some implementations, the method may comprise receiving a source image. In some aspects, the method may comprise processing the source image with a dewarping algorithm, where the dewarping algorithm warps the source image based on predefined parameters of a target projection surface; and projecting a warped image into a warped projection to an intermediate image plane in proximity to an image relay and deflection subsystem, where projected warped projection at the intermediate image plane may be projected onto the target projection surface by an image relay and deflection subsystem.

In some embodiments, processing may comprise transformation coefficients relating the source image coordinates to the warped projection coordinates. The processing may comprise transformation coefficients correlating source image pixel locations to warped projection pixel locations. The target projection surface may comprise a nonplanar surface geometry. The target projection surface may comprise an irregular surface geometry.

Projecting the warped projection in free space to the intermediate image plane may occur from a light source through a projection optics. The image relay and deflection subsystem may comprise a relay optics and a second fold mirror group. The method may include aligning the warped projection with the image relay and deflection subsystem. The intermediate image plane may be variable distances. The projecting may be constant across variable distances. The method may include generating the dewarping algorithm. The method may include receiving predefined parameters of the target projection surface. The method may include generating predefined parameters of the target projection surface.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings that are incorporated in and constitute a part of this specification illustrate several embodiments of the disclosure and, together with the description, serve to explain the principles of the disclosure:

FIG. 1 illustrates an exemplary remote image projection system, according to some embodiments of the present disclosure.

FIG. 2 illustrates an exemplary remote image projection system comprising a projection subsystem and an image relay and deflection subsystem, according to some embodiments of the present disclosure.

FIG. 3 illustrates an exemplary remote image projection system comprising a projection subsystem and an image relay and deflection subsystem, according to some embodiments of the present disclosure.

FIG. 4 illustrates an exemplary remote image projection system comprising a projection subsystem and an image relay and deflection subsystem, according to some embodiments of the present disclosure.

FIG. 5 illustrates an exemplary remote image projection system and a remotely projected image, according to some embodiments of the present disclosure.

FIG. 6 illustrates an exemplary image relay and deflection subsystem and a remotely projected image, according to some embodiments of the present disclosure.

FIG. 7A illustrates an exemplary image relay and deflection subsystem and a remotely projected image, according to some embodiments of the present disclosure.

FIG. 7B illustrates an exemplary image relay and deflection subsystem and a remotely projected image, according to some embodiments of the present disclosure.

FIG. 8A illustrates an exemplary image relay and deflection subsystem and a remotely projected image, according to some embodiments of the present disclosure.

FIG. 8B illustrates an exemplary image relay and deflection subsystem and a remotely projected image, according to some embodiments of the present disclosure.

FIG. 9 illustrates an exemplary image relay and deflection subsystem and a remotely projected image, according to some embodiments of the present disclosure.

FIG. 10A illustrates an exemplary target image, according to some embodiments of the present disclosure.

FIG. 10B illustrates an exemplary target image, according to some embodiments of the present disclosure.

FIG. 10C illustrates an exemplary target image, according to some embodiments of the present disclosure.

FIG. 10D illustrates an exemplary target image, according to some embodiments of the present disclosure.

FIG. 10E illustrates an exemplary target image, according to some embodiments of the present disclosure.

FIG. 10F illustrates an exemplary target image, according to some embodiments of the present disclosure.

FIG. 10G illustrates an exemplary target image, according to some embodiments of the present disclosure.

FIG. 11A illustrates an exemplary remotely projected image, according to some embodiments of the present disclosure.

FIG. 11B illustrates an exemplary remotely projected image, according to some embodiments of the present disclosure.

FIG. 12 illustrates an exemplary process for image correction transformation function procedure, according to some embodiments of the present disclosure.

FIG. 13A illustrates an exemplary projection subsystem, according to some embodiments of the present disclosure.

FIG. 13B illustrates an exemplary projection subsystem, according to some embodiments of the present disclosure.

FIG. 13C illustrates an exemplary projection subsystem, according to some embodiments of the present disclosure.

FIG. 14 illustrates an exemplary projection subsystem, according to some embodiments of the present disclosure.

FIG. 15A illustrates an exemplary image relay and deflection subsystem, according to some embodiments of the present disclosure.

FIG. 15B illustrates an exemplary image relay and deflection subsystem, according to some embodiments of the present disclosure.

FIG. 15C illustrates an exemplary image relay and deflection subsystem, according to some embodiments of the present disclosure.

FIG. 15D illustrates an exemplary image relay and deflection subsystem, according to some embodiments of the present disclosure.

FIG. 16A illustrates an exemplary image relay and deflection subsystem, according to some embodiments of the present disclosure.

FIG. 16B illustrates an exemplary image relay and deflection subsystem and a projection surface, according to some embodiments of the present disclosure.

FIG. 17A illustrates an exemplary remote image projection system and a projection surface, according to some embodiments of the present disclosure.

FIG. 17B illustrates an exemplary remote image projection system and a projection surface, according to some embodiments of the present disclosure.

FIG. 18 illustrates an exemplary remote image projection system and a projection surface, according to some embodiments of the present disclosure.

FIG. 19 illustrates an exemplary remote image projection system and a projection surface, according to some embodiments of the present disclosure.

FIG. 20A illustrates an exemplary remote image projection system and a projection surface, according to some embodiments of the present disclosure.

FIG. 20B illustrates an exemplary remote image projection system and a projection surface, according to some embodiments of the present disclosure.

FIG. 21A illustrates an exemplary remote image projection system and a projection surface, according to some embodiments of the present disclosure.

FIG. 21B illustrates an exemplary remote image projection system and a projection surface, according to some embodiments of the present disclosure.

FIG. 22 illustrates an exemplary remote image projection system and a projection surface, according to some embodiments of the present disclosure.

FIG. 23 illustrates an exemplary method for projecting a remote image.

FIG. 24 illustrates an exemplary method for projecting a remote image.

FIG. 25 illustrates an exemplary method for interpolating a source image.

### DETAILED DESCRIPTION

The present disclosure provides generally for a system and method for remote image projection, particularly a compact optical system to provide remote projections of images. The system may comprise a compact optical system to provide remote projections of images. The system may comprise an image correction subsystem, an image motion and positioning subsystem, an image relay and deflection subsystem, a source image, a warped image, a remotely projected image. The method may comprise processing the source image with a dewarping algorithm. The image correction subsystem may comprise a source image, a dewarping algorithm. When the system comprises an intermediate image plane, the warped image may be configured to project on the target projection surface upon arrival to the intermediate image plane. The image relay and deflection subsystem may comprise passive mechanical relay optics to refine the remotely projected image and direct the remotely projected image to the target projection surface. The dewarping algorithm may utilize machine learning to optimize the projection of the warped image to resemble the source image.

In the following sections, detailed descriptions of examples and methods of the disclosure will be given. The description of both preferred and alternative examples, though thorough, are exemplary only, and it is understood to those skilled in the art that variations, modifications, and alterations may be apparent. It is therefore to be understood that the examples do not limit the broadness of the aspects of the underlying disclosure as defined by the claims.

### Glossary

Remote Image Projection System (RIPS): as used herein refers to a system that may project a warped image onto a surface, wherein the surface may comprise a nonplanar geometry. A RIPS may process a source image through an image correction subsystem, wherein a dewarping algorithm may warp the source image creating a warped projection. The warped projection may be projected from a projection subsystem across an intermediate image plane to an IRDS, which may allow for projection of a remotely projected image.
Image Motion and Positioning Subsystem (IMPS): as used herein refers to a subsystem of the projection subsystem that controls positioning of the projection across the intermediate image plane. In some aspects, the IMPS may ensure that the projection location is in the correct position relative to the relay optics of the IRDS when the IRDS moves.
Source image: as used herein refers to an original image to be projected onto a target projection surface. In some embodiments, the image may be static, animated such as a video, and may contain text content, as non-limiting examples.
Warped projection: as used herein refers to a projection processed by an image correction subsystem to adjust for display of the remotely projected image. A source image may be converted into a warped projection through an image correction subsystem. In some aspects, a source image may be processed into a warped image that may be provided to create a warped projection.
Dewarping algorithm: as used herein refers to an algorithm that may be used to process a source image into a warped projection.
Image Correction Subsystem (ICS): as used herein refers to a system to may correct optical distortions resulting from an oblique angle of incidence or irregularities of a target projection surface, particularly those that are not planar.
Image Relay and Deflection Subsystem (IRDS): as used herein refers to a passive set of optical and mechanical components required to capture a warped projection and relay it to a target projection surface.
Remotely Projected Image (RPI): as used herein refers to an undistorted image or an image with limited distortion of the source image. A remotely projected image is created by projecting a warped projection onto a target projection surface. In some embodiments, the image may be static, animated such as a video, and may contain text content, as non-limiting examples.
Intermediate Image Plane: as used herein refers to free space between a projection subsystem and an image relay and deflection subsystem. More specifically, the intermediate image plane exists between a first mirror group of the projection system and relay optics of the IRDS. In some embodiments, the intermediate image plane may be variable distances, and the remotely projected image may be constant. In some aspects, an IMPS may adjust the light engine as the intermediate image plane changes.
Projection Subsystem: as used herein refers to an active system that receives a source image and projects a warped projection to an IRDS.
Target Projection Surface: as used herein refers to the surface onto which a warped projection may be projected to display a remotely projected image. In some aspects, a target projection surface may comprise a non-flat surface geometry, such as an irregular surface geometry or nonplanar surface geometry.
Coded Image: as used herein refers to an image comprised of calibrated points that are used with the dewarping algorithm to form technical correlations between the source image and the RPI. In some embodiments, the coded image may comprise color with a plurality of hue, saturation, and luminance, as non-limiting attributes, that are used in conjunction with sensors within the RIPS to calibrate the attributes of the RPI.

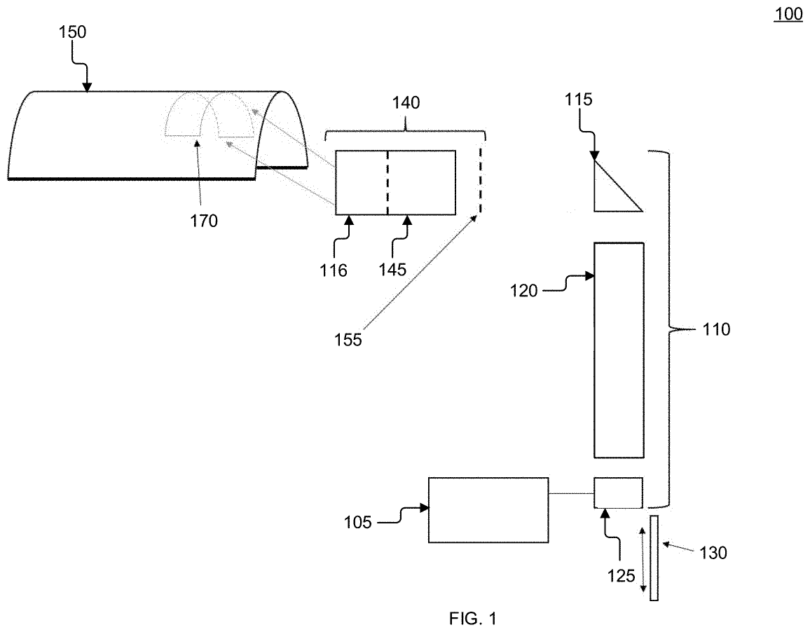

Referring now to FIG. 1, an exemplary remote image projection system (RIPS)100 is illustrated. In some embodiments, the RIPS 100 may comprise a projection subsystem 110. In some implementations, the projection subsystem 110 may comprise a light engine 125 in logical communication with the ICS 105. In some aspects, the light engine 125 may transmit the warped projection. In some embodiments, the projection subsystem 110 may comprise projection optics 120, wherein the warped projection is formed to a predetermined size. In some implementations, the projection subsystem 110 may comprise a fold mirror group 115, 116 configured to redirect the warped projection.

In some implementations, the RIPS 100 may comprise an image relay and deflection subsystem (IRDS) 140. In some embodiments, the RIPS 100 may comprise an image relay and deflection subsystem (IRDS) 140 configured to receive a warped projection from the projection subsystem 110. In some implementations, the received warped projection may be transmitted through an intermediate image plane 155. In some aspects, the IRDS 140 may comprise relay optics 145 that focus the warped projection. In some embodiments, the IRDS 140 may comprise a fold mirror group 116 configured to adjust an angle of the warped projection and project the warped projection onto the target projection surface 150. In some implementations, the warped projection on the target projection surface 150 may replicate the source image as a RPI 170.

In some aspects, the projection subsystem 110 may comprise an image motion and positioning subsystem (IMPS) 130. In some embodiments, an IMPS may reposition a light engine 125 vertically and horizontally. In some implementations, an IMPS may use a micro-mirror array to keep an intermediate image plane 155 location in a position relative to the relay optics 145 when the IRDS 140 moves.

In some aspects, an IMPS 30 may use an opto-mechanical zoom where the light engine moves as the position on the projection surface changes and the Image Relay and Deflection Subsystem 140 and Intermediate Image Plane 155 move together. In some embodiments, an IMPS 130 may use an optical zoom where the lens components in the Projection Subsystem 110 move as the position on the projection surface 150 changes and the Image Relay and Deflection Subsystem 140 and Intermediate Image Plane 155 move together. In some implementations, an IMPS may use a mechanical zoom where the lens components in the Projection Subsystem 110 move as the position on the projection surface 150 changes and the Image Relay and Deflection Subsystem 140 and Intermediate Image Plane 155 move together.

In some embodiments, the RIPS 100 may comprise an image correction subsystem (ICS) 105. In some aspects, the ICS 105 may comprise a dewarping algorithm. In some implementations, the ICS 105 may be configured to receive a source image. In some aspects, the application of the source image to the dewarping algorithm may transmit a warped projection 1090. In some embodiments, the warped projection may be based on predefined parameters of the target projection surface 150.

In some aspects, the total magnification between light engine 125 and projection surface 150 may range from 5× to 60×. In some embodiments, the surface normal at the center of the warped projection may be 90 degrees to the line of sight of the relay optics 145 within the IRDS 140. In some implementations, the projection angle, as measured from the projection surface normal to the center of the warped projection may range from 0 degrees to 70 degrees. In some aspects, the distance from the fold mirror group 115 in the projection subsystem 110 to the intermediate image plane in the IRDS 140 may be adjustable by to a predetermined distance without significant change to image size, quality, or brightness, as non-limiting examples.

In some implementations, the RIPS 100 may comprise an alignment subsystem. In some aspects, an alignment subsystem may comprise an alignment telescope inserted after a projector lens element. In some embodiments, an alignment target may be projected onto an alignment cap. In some implementations, an alignment target consists of horizontal and vertical lines centered on a projector display. In some aspects, an alignment telescope may include a fold mirror 115 or beam splitter. In some embodiments, a fold mirror 115 or beam splitter may help an alignment telescope to reflect images from an alignment cap on an image relay lens. In some implementations, an alignment cap may be co-linear with an image relay lens' optical axis.

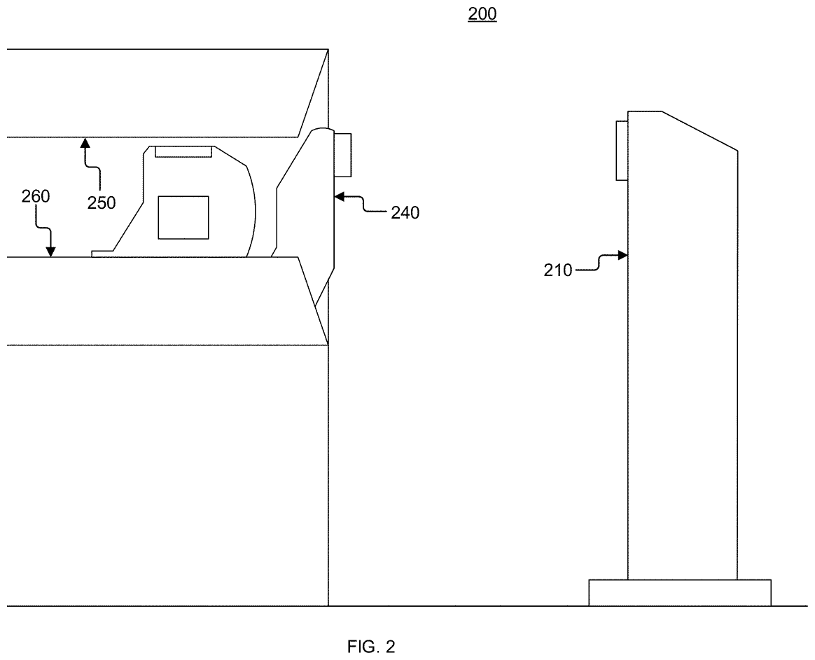

Referring now to FIG. 2, an exemplary remote image projection system (RIPS) 200 comprising a projection subsystem 210 and an image relay and deflection subsystem (IRDS) 240 is illustrated. In some embodiments, the RIPS 200 may comprise a projection subsystem 210. In some implementations, the RIPS 200 may comprise a light engine, wherein the light engine transmits a projection. In some aspects, the light engine may be adjustable to provide clarity to the projection. In some embodiments, the motion of the light engine may be controlled by an image motion and positioning subsystem.

In some implementations, the RIPS 200 may comprise an image relay and deflection subsystem 240. In some aspects, the IRDS 240 may comprise an intermediate image plane, wherein the warped projection from the projection subsystem 210 is received. In some embodiments, the IRDS 240 may comprise relay optics. In some implementations, the relay optics may focus the warped projection. In some embodiments, the IRDS 240 may comprise a fold mirror group configured to adjust the angle of the warped projection. In some aspects, the projection may form a remotely projected image configured to present the warped projection on a projection surface 250.

In some embodiments, the angle of the warped projection may be calculated to exceed external obstacles. For example, the angle of the fold mirror group used in an IRDS 240 in a magnetic resonance image (MRI) machine may be sufficient to project a remotely projected image on the interior of the MRI machine while avoiding projection obstruction that may be caused by a head coil or positioning apparatus 260 within the MRI machine. In some aspects, an IRDS may comprise materials benign to operation in a high strength magnetic field.

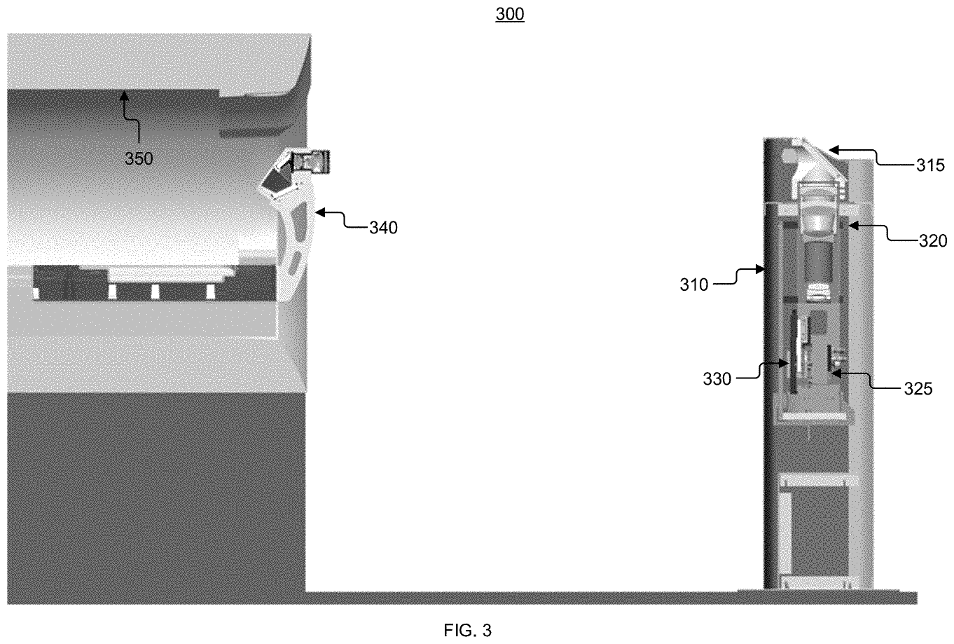

Referring now to FIG. 3, an exemplary remote image projection system (RIPS) 300 comprising a projection subsystem and an image relay and deflection subsystem (IRDS) 340 is illustrated. In some embodiments, the RIPS 300 may comprise a projection subsystem 310. In some implementations, the RIPS 300 may comprise a light engine 325, wherein the light engine 325 transmits a warped projection. In some aspects, the light engine 325 may be adjustable to provide clarity to the warped projection. In some embodiments, the motion of the light engine 325 may be controlled by an image motion and positioning subsystem 330.

In some implementations, the IMPS 330 may comprise projection optics 320. In some aspects, projection optics 320 may ensure the warped projection is formed to a predetermined size. In some embodiments, the IMPS 330 may comprise a fold mirror group 315 that may redirect the warped projection. In some implementations, the RIPS 300 may comprise an image relay and deflection subsystem 340.

In some aspects, the IRDS 340 may comprise an intermediate image plane, wherein the warped projection from the projection subsystem 310 is received. In some embodiments, the IRDS 340 may comprise relay optics. In some implementations, the relay optics may focus the warped projection. In some implementations, the IRDS 340 may comprise a fold mirror group 315 configured to adjust the angle of the projection. In some aspects, the projection may form a remotely projected image configured to present the warped projection on a projection surface 350. This projection may avoid potential external obstacles such as a positioning apparatus via predetermined angles in the IRDS 340.

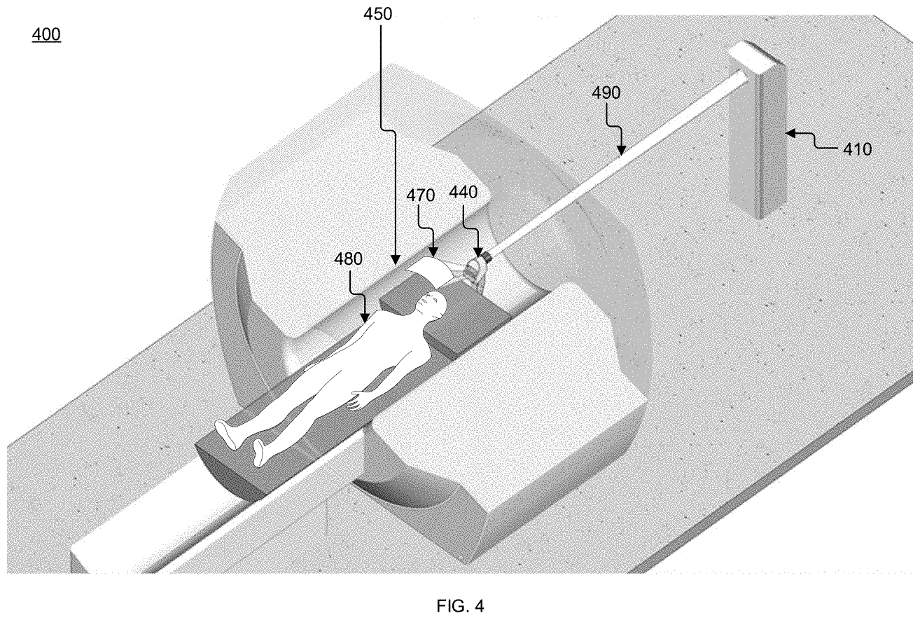

Referring now to FIG. 4, an exemplary remote image projection system (RIPS) 400 comprising a projection subsystem 410 and an image relay and deflection subsystem (IRDS) 440 is illustrated. In some embodiments, the RIPS 400 may comprise a projection subsystem 410. In some implementations, the RIPS 400 may comprise an IRDS 440. In some embodiments, the IRDS 440 may comprise relay optics. In some implementations, the relay optics may focus the projection 490. In some aspects, the projection 490 may form a remotely projected image (RPI) 470 configured to present the projection 490 on a projection surface 450. In some embodiments, the RPI 470 may be positioned in a viewable location on the projection surface 450 for the observation of a user 480.

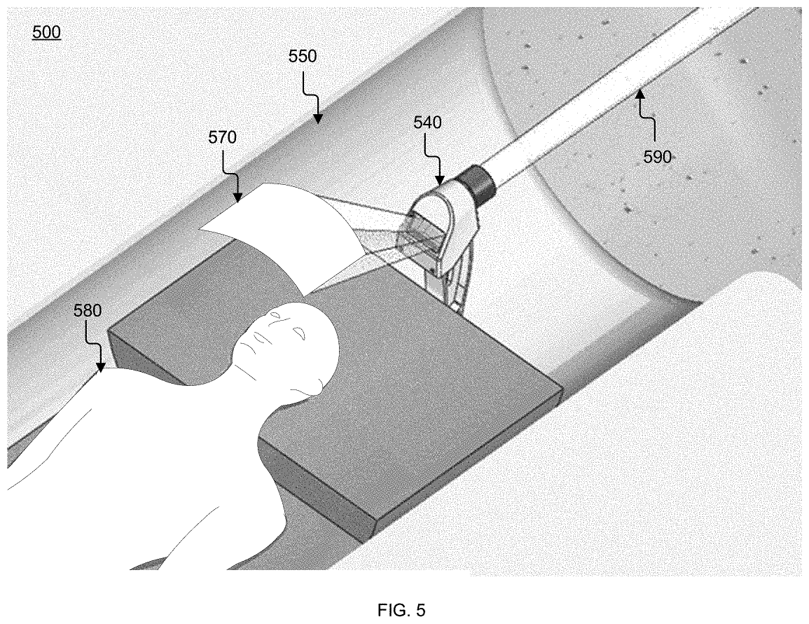

Referring now to FIG. 5, an exemplary remote image projection system (RIPS) 500 and a remotely projected image (RPI) 570 is illustrated. In some implementations, the RIPS 500 may comprise an image relay and deflection subsystem (IRDS) 540. In some embodiments, the IRDS 540 may comprise relay optics. In some implementations, the relay optics may focus the projection 590. In some aspects, the projection 590 may form a RPI 570 configured to present the projection 590 on a projection surface 550. In some embodiments, the RPI 570 may be positioned in a viewable location on the projection surface 550 for the observation of a user 580. In some implementations, the RPI may display a static, animated, or live video, by way of non-limiting example.

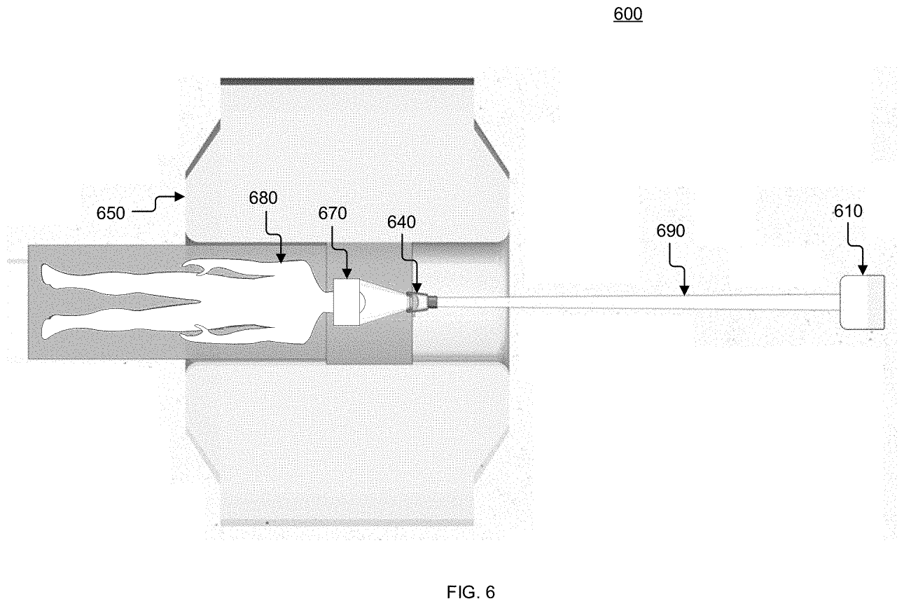

Referring now to FIG. 6, an exemplary remote image projection system (RIPS) 600 and a remotely projected image (RPI) 670 is illustrated. In some embodiments, the RIPS 600 may comprise a projection subsystem 610. In some implementations, the RIPS 600 may comprise an IRDS 640. In some embodiments, the IRDS 640 may comprise relay optics. In some implementations, the relay optics may focus the projection 690. In some aspects, the projection 690 may form a remotely projected image (RPI) 670 configured to present the projection 690 on a projection surface 650. In some embodiments, the RPI 670 may be positioned in a viewable location on the projection surface 650 for the observation of a user 680.

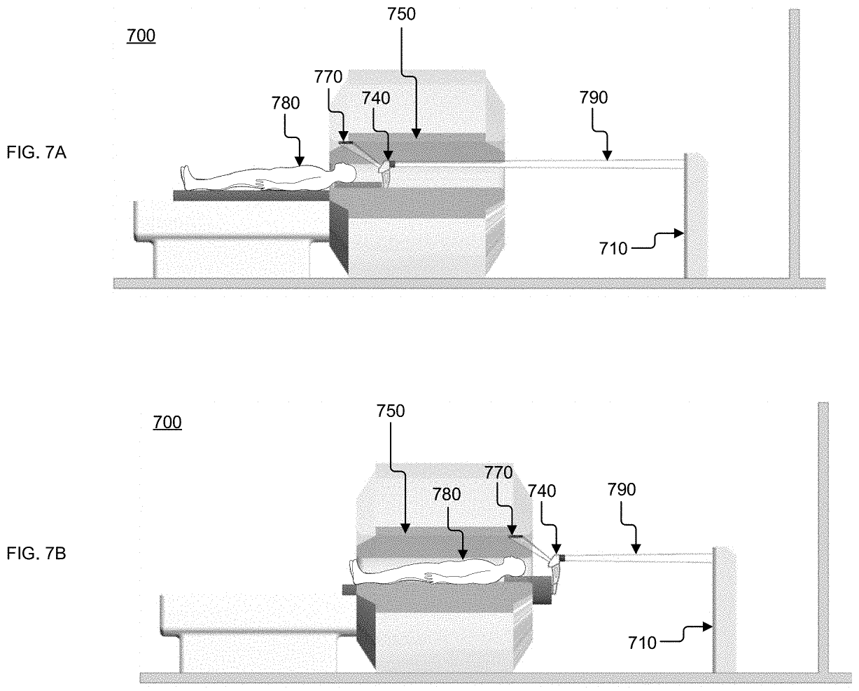

Referring now to FIG. 7, an exemplary image relay and deflection subsystem and a remotely projected image is illustrated. In some embodiments, the RIPS 700 may comprise a projection subsystem 710. In some implementations, the RIPS 700 may comprise an IRDS 740. In some embodiments, the IRDS 740 may comprise relay optics. In some implementations, the relay optics 745 may focus the projection 790. In some aspects, the projection 790 may form a remotely projected image (RPI) 770 configured to present the projection 790 on a projection surface 750. In some embodiments, the RPI 770 may be positioned in a viewable location on the projection surface 750 for the observation of a user 780.

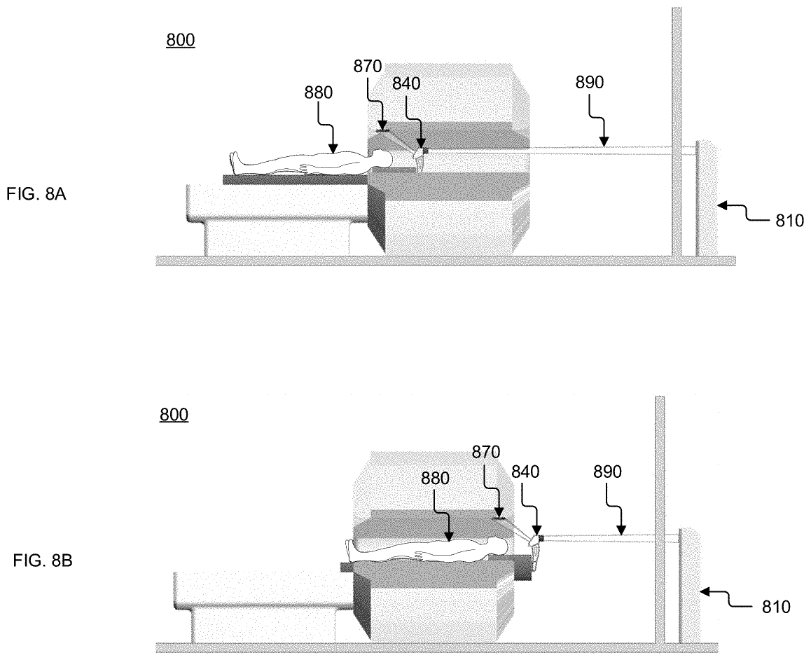

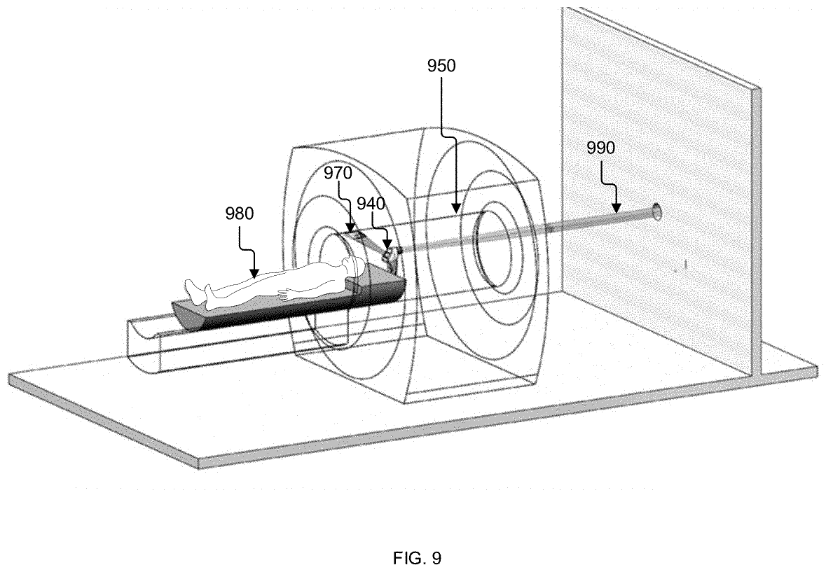

Referring now to FIG. 8A, an exemplary image relay and deflection subsystem 840 and a remotely projected image 870 is illustrated. In some implementations, the projection subsystem 810 may lie behind the IRDS 840 with a barrier between the subsystems. In some embodiments, the projection subsystem 810 may remain in a fixed position despite other components of the remote image projection system 800 moving. For example, the IRDS 840 may move horizontally while the projection subsystem 810 remains stable.

Referring now to FIG. 8B, an exemplary image relay and deflection subsystem 840 and a remotely projected image 870 is illustrated. In some embodiments, the IRDS 840 may comprise a positioning mechanism, wherein the device moves with the users 880 viewing angle. In some aspects, the IRDS 840 may be fixed onto a device within the remote image projection system 800. For example, when the user 880 moves positions the IRDS 840 may be at a fixed distance above the users 880 head at all times. In some implementations, the projection subsystem 810 may comprise projection optics with a light engine, whereby the projection 890 may be corrected regardless of the distance from the intermediate image plane.

Referring now to FIG. 9, an exemplary image relay and deflection subsystem 940 and a remotely projected image 970 is illustrated. In some embodiments, the projection subsystem may be positioned behind a barrier. In some aspects, the barrier may be transparent and allow for the projection 990 to pass through intact. In some embodiments, the projection subsystem may remain in a singular position behind the barrier. In some implementations, the projection subsystem may comprise a positioning mechanism, wherein the device may be moved horizontally or vertically from the barrier.

In some aspects, the IRDS 940 may remain a fixed distance from the projection subsystem. In some implementations, the IRDS 940 may endure image correction despite the distance from the projection subsystem. In some aspects, the RPI 970 may comprise an exact angle to the projection surface 950, whereby the user 980 may view an accurate image. In some embodiments, the RPI 970 may comprise a multitude of angles, wherein the users 980 physical features may affect their viewing of an image. In some implementations, the projection 990 may continue being displayed despite being obstructed for periods of time.

In some implementations, the projection 990 may originate behind a barrier. For example, a small hole may be made the wall of a building and the projection 990 may exit through to the IRDS 940. In some aspects, the RPI 970 may be forecast onto the projection surface 950. In some implementations, the RPI 970 may be viewed by the user while inside a device. For example, the RPI 970 may be displayed onto the underside of an MRI machine for the user's 980 viewing.

In some embodiments, the IRDS 940 may comprise a positioning mechanism, wherein the RPI 970 may be displayed in the center of the projection surface 950. In some implementations, the RPI 970 may undergo image correction prior to being displayed on the projection surface 950. In some embodiments, the RPI 970 may continue being displayed despite being obstructed.

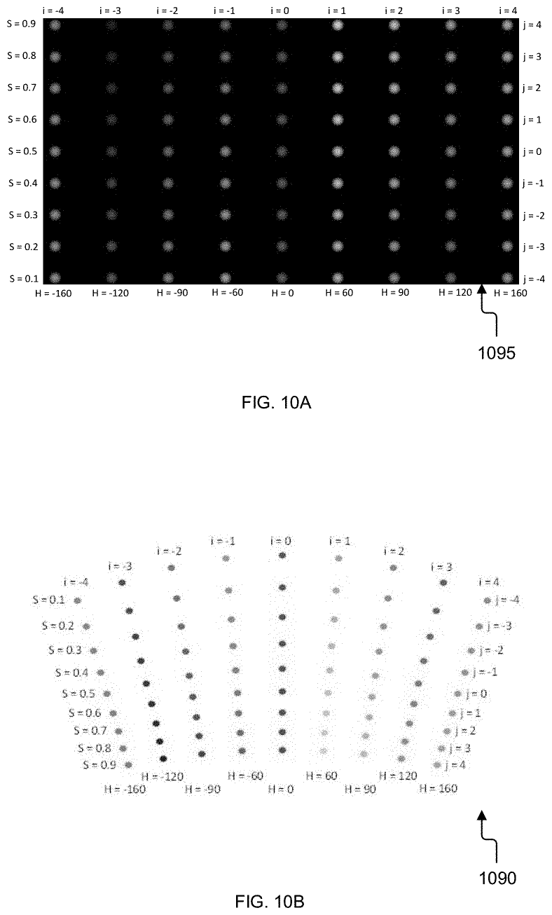

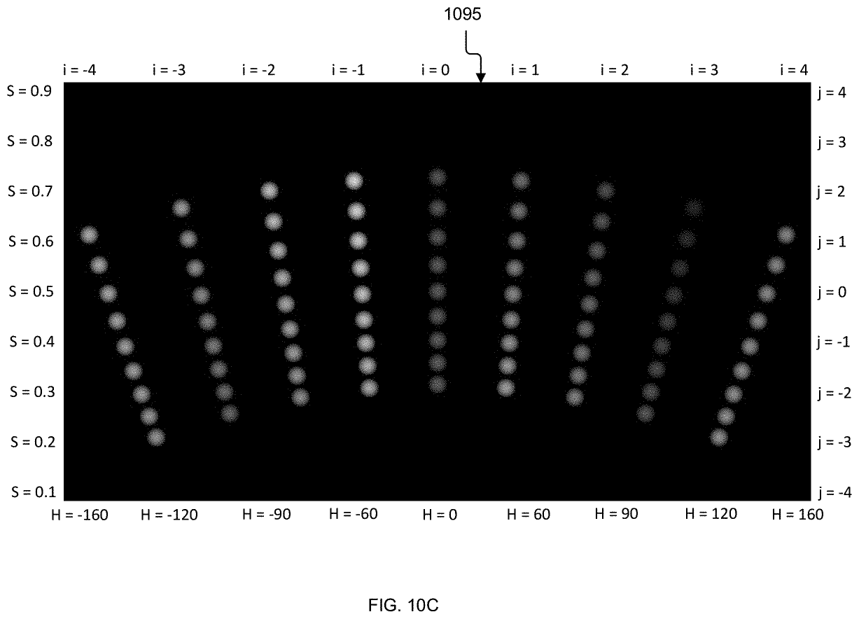

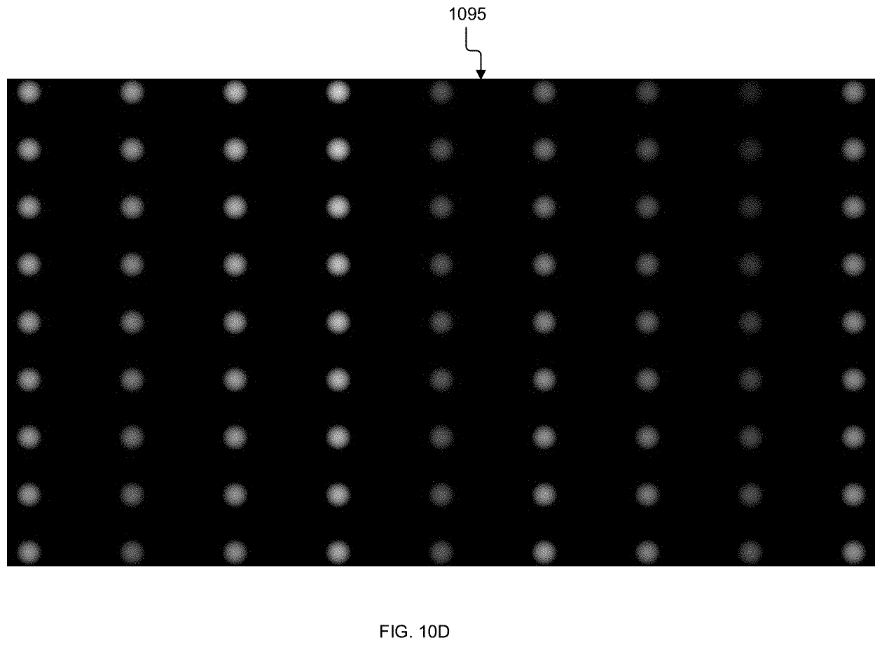

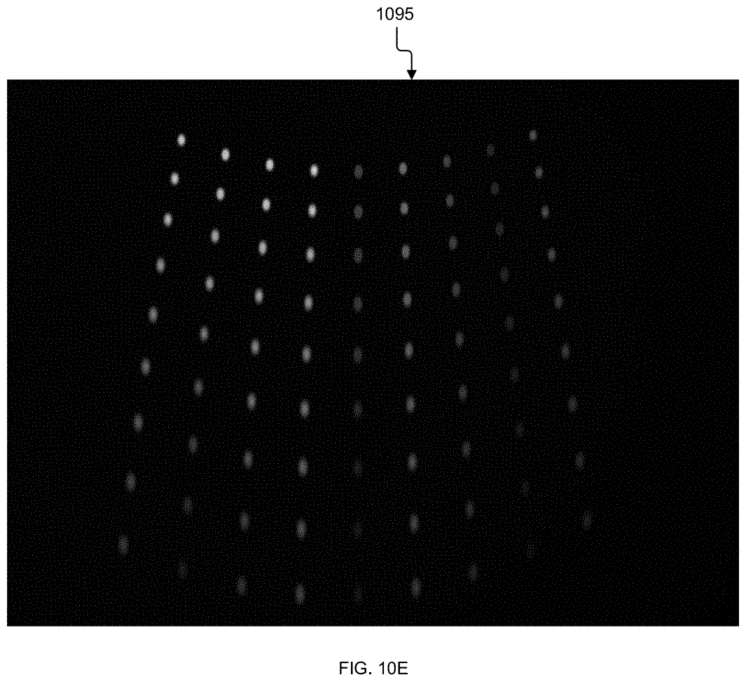

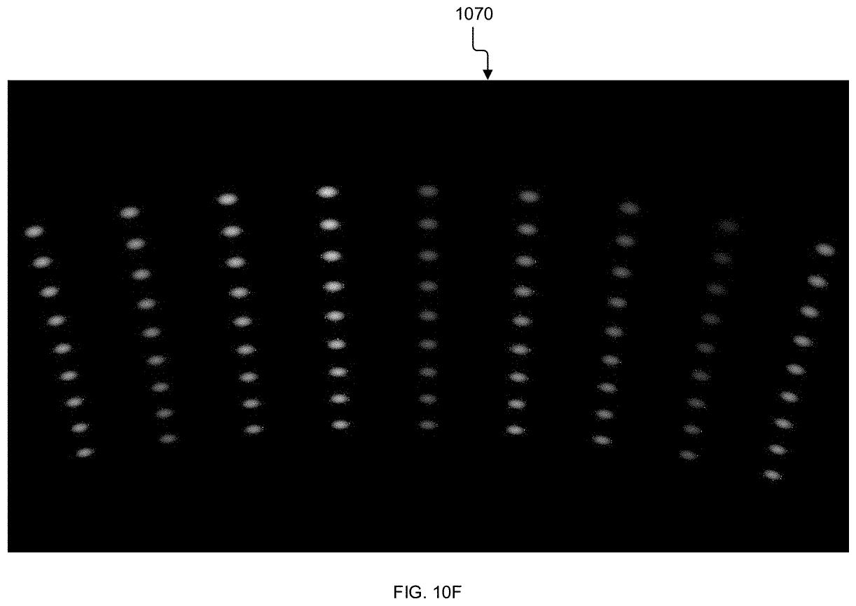

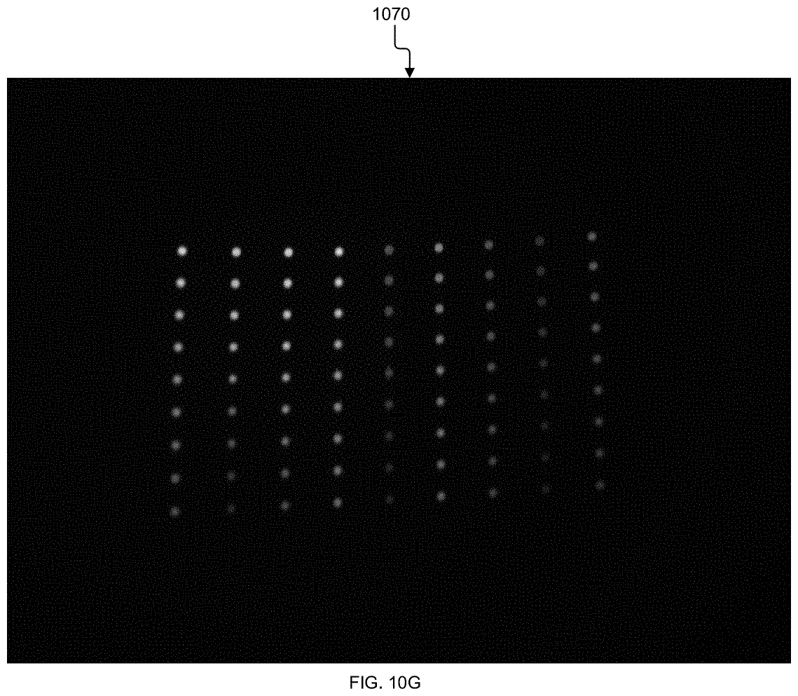

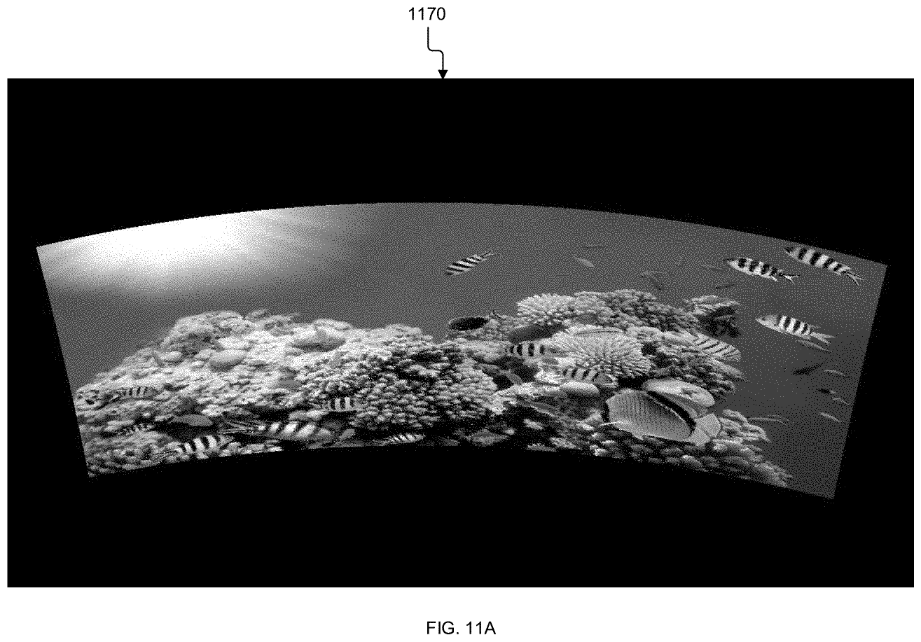

Referring now to FIG. 10A-F, an exemplary coded image 1095 is illustrated. In some embodiments, the image correction subsystem (ICS) may comprise a coded image 1095. In some implementations, the ICS may provide correction for optical distortions resulting from the oblique angle of incidence on the projection surface, particularly those which are not planar. In some implementations, the ICS may produce a warped projection that provides an undistorted image on a nonplanar surface.

In some aspects, the ICS may create the warped projection 1090 via manipulation of the source image. In some embodiments, the coded image 1095 may be used to determine the source image distortion that may produce the warped projection 1090. In some implementations, the coded image 1095 may comprise a Hue, Saturation, Intensity (HSI) or Hue, Saturation, Luminance (HSL) image. The coded image 1095 may comprise a plurality of color-coded dots in a predetermined array. In some embodiments, the remote image projection system (RIPS) may comprise a calibrated color camera that calibrates the ICS based on feedback received from the coded image 1095 on the target projection surface.

In some aspects, the coded image 1095 may provide a recursive calibration that the ICS may use to verify warping parameters defined by a dewarping algorithm. In some embodiments, the dewarping algorithm of the ICS may comprise machine learning to recursively refine the dewarping algorithm until the resulting warped projection is within the predetermined warping parameters. In some implementations, the warping parameters produced by the dewarping algorithm may provide clarity to the warped projection 1090 on a nonplanar target projection surface. In some aspects, the warped projection 1090 may produce a RPI 1070 on the projection surface.

In some aspects, the ICS may be achieved by optical means. In some embodiments, the ICS may utilize the optical keystone correction method. In some implementations, the ICS may utilize the optical keystone correction method as a portion of the method for forming a warped projection 1090. In some aspects, the ICS may comprise a generalized conic ‘cylindrical’ mirror to correct for warping on the curved surface. The dewarping algorithm may comprise the utilization of a conic mirror for generic surface applications.

For example, the warped projection 1090 may reflect from a conic mirror when the RIPS determines the target projection surface comprises a constant radius of curvature common to many external surfaces without intermediate extrusions in the intended frame of projection. In some embodiments, the dewarping algorithm may comprise a predetermined resolution tolerance to for generic nonplanar target projection surfaces. In some implementations, the RIPS may comprise an anamorphic lens system to shrink the image in the ‘vertical’ direction. In some aspects, the ICS may comprise an anamorphic lens system to decrease computational times for algorithm generation. For example, the dewarping algorithm may comprise predefined parameters that form the source image to generic warping dimensions that the ICS refines based on feedback from the coded image 1095 on the target projection surface.

In some embodiments, the ICS may comprise a combination of optical and electronic components. In some implementations, the ICS may produce a warped projection 1090 via electronic manipulation of the light engine. As an illustrative example, the ICS may project a coded image 1095 onto a target projection surface. The coded image 1095 may transmit via an anamorphic lens system that provides an estimated form for the target projection surface. Based on visual feedback from the color sensors in the RIPS, the ICS may transmit signals to the image motion and positioning subsystem (IMPS) to move the light engine closer to the projection optics to shape the warped projection 1090.

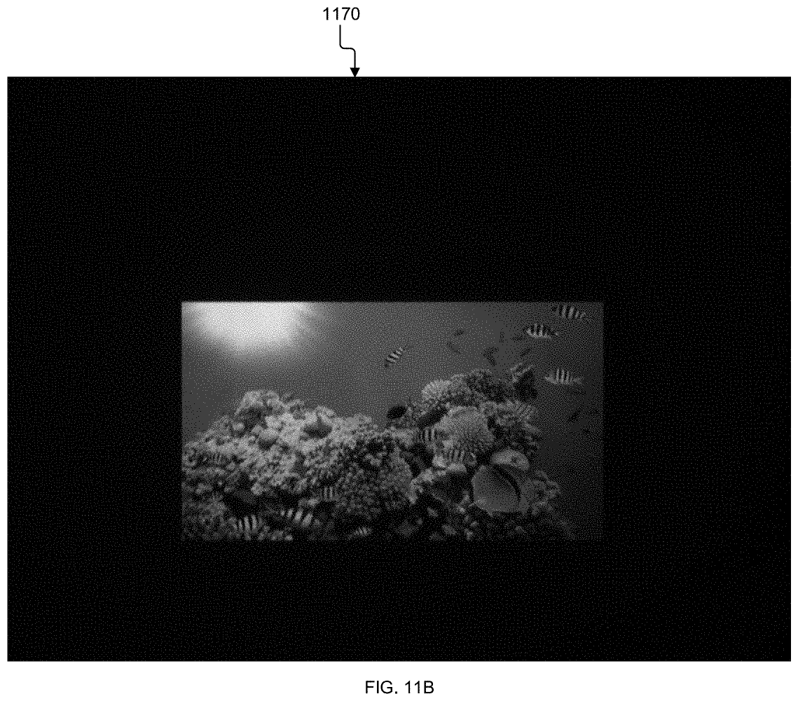

Referring now to FIG. 11A-B, an exemplary remotely projected image (RPI) 1170 is illustrated. In some embodiments, the RPI 1170 may comprise a plurality of hues, intensity, saturation, luminance, as a non-limiting list of attributes. In some implementations, the image correction subsystem (ICS) may produce a warped projection that may comprise modifications to these attributes that compensate for the diminishing effect of transmission of the warped projection to the target projection surface.

For example, a RPI 1170 of an aquarium may comprise a warped projection with a hue of blue that differs from the source image. The remote image projection system may comprise sensors that detect a yellow tint to the lighting in the room and the discoloration of the blue of the warped projection may compensate for the yellow lighting to display the original blue hue of the source image.

In some aspects, the aperture of the light engine may increase to compensate for unbalanced lighting environments. The change in aperture may allow the RPI 1170 to display at a similar representation as the source image. In some embodiments, the RPI 1170 may appear of similar proportions to the source image. In some implementations, the warped project may render as an unwarped RPI 1170 to the user.

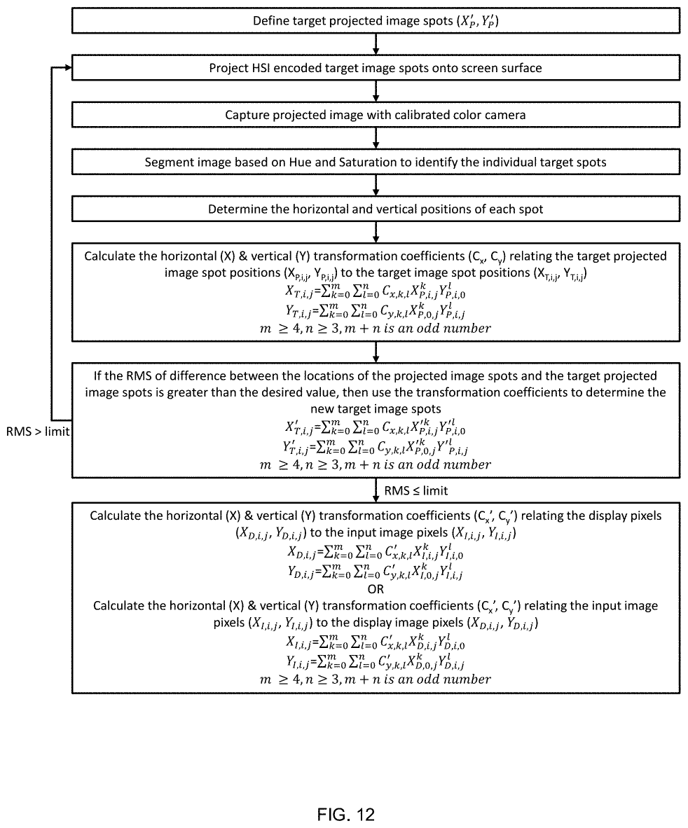

Referring now to FIG. 12, an exemplary process for creating a remotely projected image (RPI) is illustrated. In some embodiments, the image correction subsystem (ICS) may comprise a coded image. In some implementations, the ICS may define target projected image spots for the projection of the coded image. In some aspects, the ICS may project the coded image onto the target projection surface. The coded image may comprise a plurality of color-coded dots in a predetermined array. In some embodiments, the remote image projection system (RIPS) may comprise a calibrated color camera that calibrates the ICS based on feedback received from the coded image on the target projection surface.

In some implementations, the ICS may segment the coded image feedback based on attributes such as, but not limited to, hue and saturation to identify individual target dots. In some aspects, the ICS may determine the horizontal and vertical location of each dot. In some embodiments, the ICS may comprise a dewarping algorithm. In some implementations, the dewarping algorithm may calculate the horizontal and vertical transformation coefficients relating the dot positions of the projected coded image to the dot positions in the source image.

In some embodiments, the ICS may utilize tessellation to reduce the complexities of a nonplanar surface for computational purposes. In some aspects, the computation of dot positions may comprise matrix based computations whose dimensions are defined by the quantity of correlated dot positions. In some implementations, the dimensions of the matrices may determine the degree of polynomials applied to form the warped projection. In some embodiments, higher resolution of the RPI may be produced by increasing the quantity of dots in the coded image.

In some aspects, the root mean square (RMS) may determine the necessity of repeated iterations of the process for creating a RPI. In some embodiments, the difference between the locations of the coded image dots and the source image dots may determine the need for reiteration. In some implementations, the RMS of the difference of the dot locations may necessitate the use of the transformation coefficients to determine new locations for the projected coded image dots. In some aspects, the RMS may continue to initiate a reiteration of the computational process until the RMS is less than a predetermined threshold value.

In some embodiments, the ICS may calculate the horizontal and vertical transformation coefficients relating the RPI pixels to the source image pixels. In some implementations, the dewarping algorithm may calculate the horizontal and vertical transformation coefficients relating source image pixels to the warped projection pixels. In some aspects, the dewarping algorithm may calculate the horizontal and vertical transformation coefficients relating warped projection pixels to the RPI pixels. In some embodiments, the calculations for pixel locations may comprise matrices composition that comprises a plurality of variables correlated with the dot locations of the coded image. In some implementations, the dewarping algorithm may comprise polynomials whose degree is determined by the associated matrices.

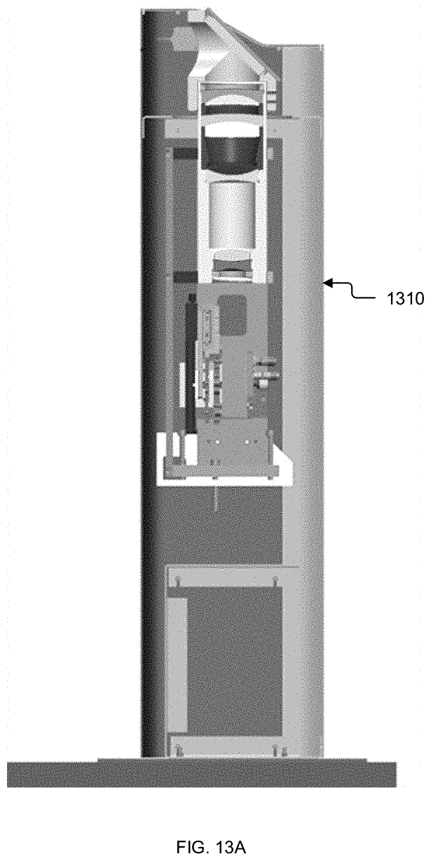

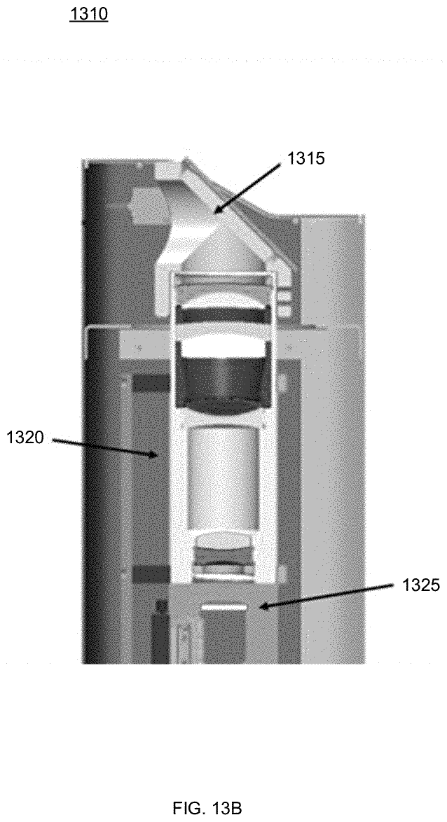

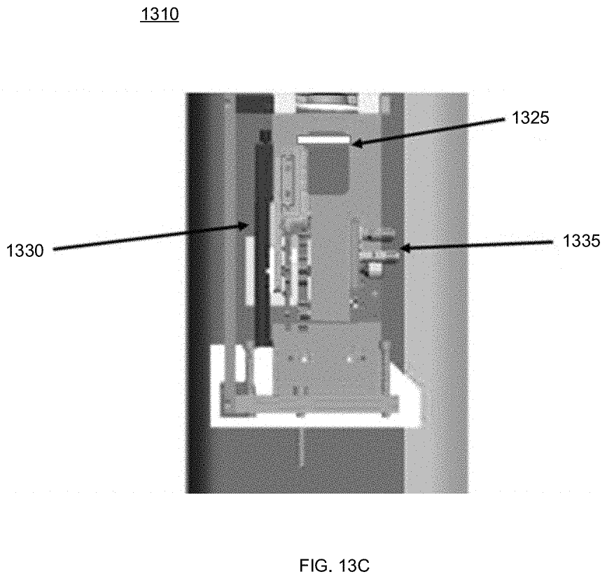

Referring now to FIGS. 13A-13C, an exemplary projection subsystem 1310 is illustrated. In some embodiments, the projection subsystem 1310 may comprise an outer casing, wherein all components are secured internally. In some implementations, the projection subsystem 1310 may comprise the optical and light engine components required to project a warped projection from the light engine 1325 to an intermediate image plane which is utilized by the IRDS. In some aspects, the warped image in the intermediate image plane may be sized to match the IRDS aperture and optical conjugate requirements, and it may be well corrected for optical errors, distortion, and chromatic aberrations.

In some embodiments, the ICS may utilize external sensors and a coded image to tessellate the contours of the nonplanar projection surface. In some implementations, the dewarping algorithm may use machine learning to recursively refine the dewarping algorithm until the resulting warped projection is within the predetermined parameters of the RIPS.

In some implementations, the light engine 1325 may comprise a standard projection light engine. For example, the light engine 1325 may use a Liquid Crystal Display engine to project the image through the projection subsystem 1310. In some embodiments, the projection subsystem 1310 may comprise a telecentric mirror system, wherein parallax error characteristics are eliminated. For example, regardless of the distance from the mirror and the light engine 1325 the image may be the same size.

In some implementations, the projection subsystem 1310 may relay an image using a micro-mirror to a projection surface. In some aspects, the projection subsystem 1310 may comprise a magnification device, whereby the image height may be divided by the projection surface height. In some embodiments, the projection optics 1320 may be corrected for chromatic and monochromatic aberrations. In some implementations, the projection optics 1320 may comprise a distortion mechanism, wherein the image quality at an intermediate plane may be very high. In some aspects, the fold mirror group 1315 may contort projection optics 1320 projection to lie along the line of sight of the relay optics.

In some embodiments, the projection subsystem 1310 may comprise a moveable micro-mirror array, wherein the intermediate image location may remain in the correct position. In some implementations, the image location may need to be aligned relative to the relay optics when deflected in the projection subsystem 1310. In some aspects the light engine 1325 may move to a required position on the projection surface. In some embodiments, the light engine 1325 may comprise an opto-mechanical zoom feature, wherein the image may move provided the projection surface moves.

In some aspects, the IRDS may move simultaneously with the projection surface. For example, as the projection surface moves, the IRDS may comprise a positioning mechanism, wherein the IRDS may sense the movement of the projection surface and mimic the movement. In some implementations, the light engine 1325, motion control actuator 1330 and light engine position adjustment 1335 may move in sync to the required positioning of the image projection. In some aspects, the motion control actuator 1330 may comprise a mechanical zoom feature, wherein correct image positioning may be achieved. In some embodiments, the motion control actuator 1330 may comprise an optical zoom feature, wherein correct image positioning may be achieved.

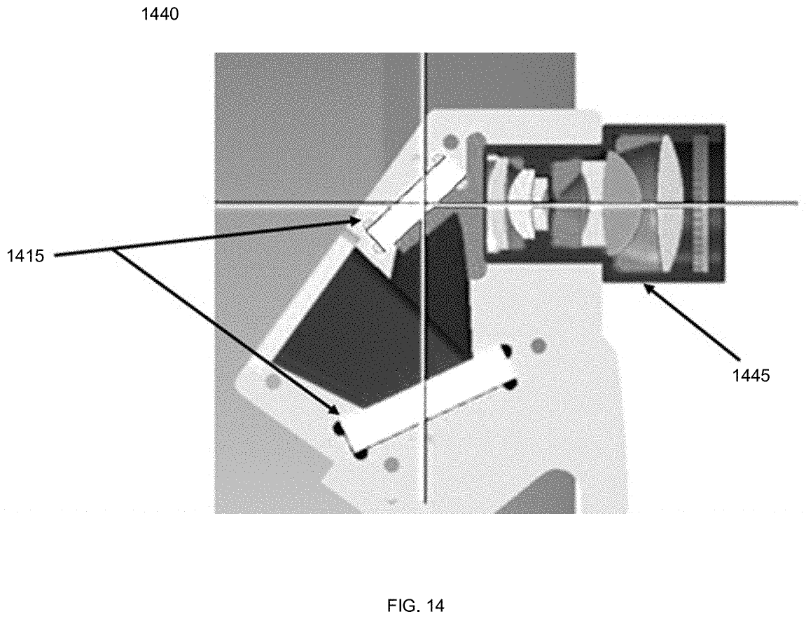

Referring now to FIG. 14, an exemplary image relay and deflection subsystem 1440 is illustrated. In some implementations, the relay optics 1445 may be telecentric on the intermediate side of the image. In some aspects, the relay optics 1445 may relay and image from an intermediate plane to a surface. In some embodiments, the relay optics 1445 may comprise a chromatic correction, wherein the axial and lateral color has been corrected. In some aspects, the relay optics 1445 may comprise monochromatic aberrations, wherein the image quality may be higher on a surface.

In some implementations, the fold mirror group 1415 may be in the line of sight of the relay optics 1445. In some aspects, the fold mirror group 1415 may be used to project the final image onto a surface at a skewed angle. In some implementations, the fold mirror group 1415 may comprise an adjacent opening, wherein light may diffract and be projected outwards.

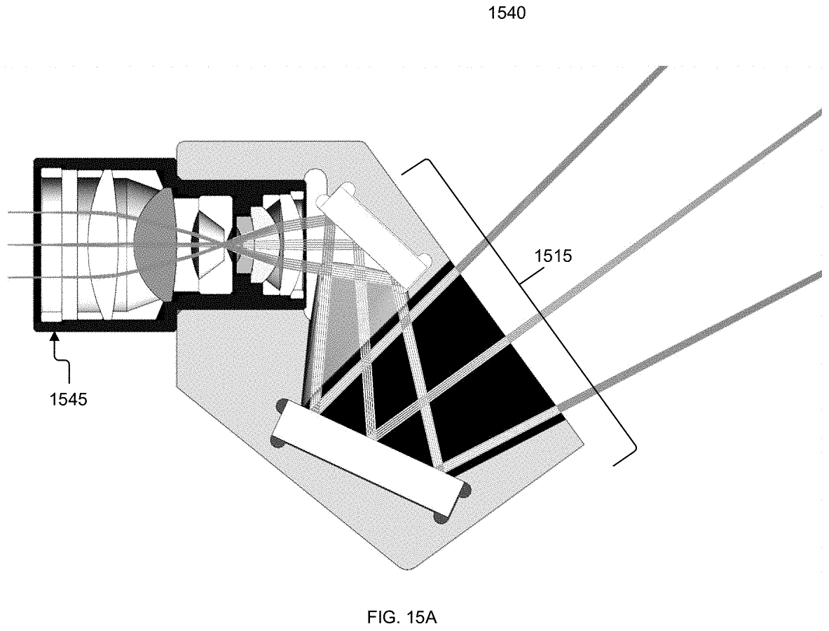

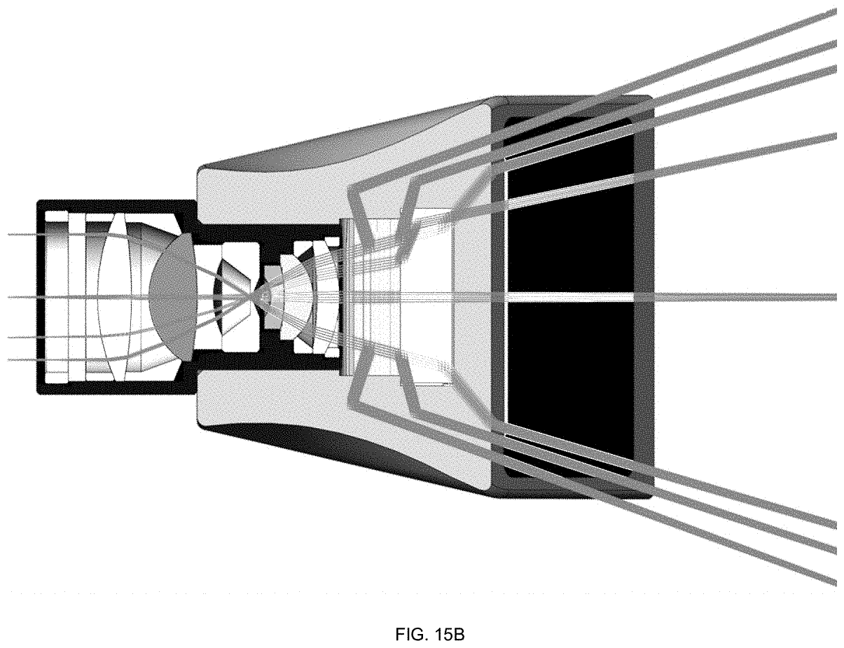

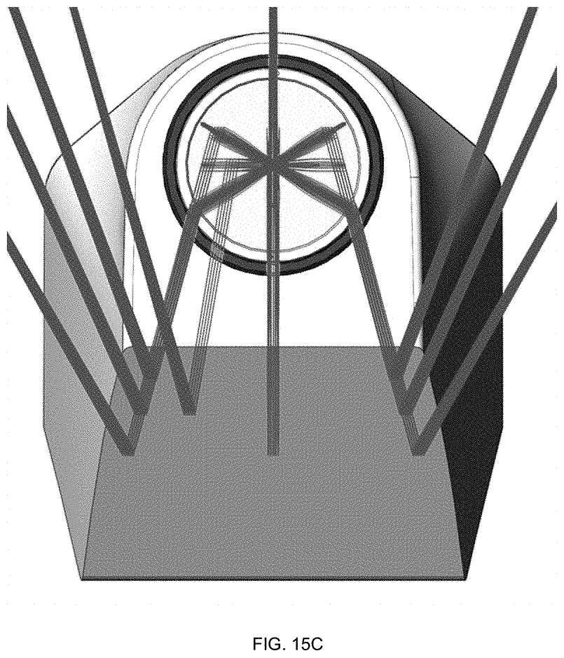

Referring now to FIG. 15A, an exemplary image relay and deflection subsystem 1540 is illustrated. In some implementations, the IRDS 1540 may comprise different angles, whereby an image may be projected at vertical or horizontal angles. In some aspects, the relay optics 1545 may comprise a separate housing from the fold mirror group 1515. In some embodiments, the IRDS 1540 may comprise a hollow interior that permits light to pass through uninterrupted. In some embodiments, the mirrors inside the IRDS 1540 may be interchanged when worn.

Referring now to FIG. 15B, an exemplary image relay and deflection subsystem is illustrated. In some embodiments, the IRDS 1540 may comprise opposite facing mirrors, whereby light may be reflected in opposite directions. In some aspects, the mirrors may be evenly spaced apart for accurate projection. In some embodiments, the mirrors may be placed different lengths apart, whereby the projection angle may be adjusted. In some aspects, the mirrors may be concaved in opposite directions to aid with diffraction.

In some embodiments, the relay optics 1545 may exist in different locations within the IRDS 1540. In some implementations the relay optics 1545 may comprise different sized mirrors within the device. In some aspects, the relay optics 1545 may be directly connected to the fold mirror group 1515. In some embodiments, the fold mirror group 1515 may comprise a singular mirror that projects light onto a surface.

Referring now to FIG. 15C, an exemplary image relay and deflection subsystem 1540 is illustrated. In some implementations, the IRDS 1540 may comprise a mirror adjacent to the opening, wherein light may immediately reflected when incident on the mirror. In some aspects, the mirror may be removed from the IRDS 1540. For example, the mirror may be taken out for cleaning purposes and may be later inserted for reuse.

Referring now to FIG. 15D, an exemplary image relay and deflection subsystem 1540 is illustrated. In some aspects, the IRDS 1540 may comprise a series of mirrors within the device, wherein light may reflect and project in different directions. In some implementations, the IRDS 1540 may comprise a hollow interior, whereby the mirrors may be moved about freely. For example, the mirrors may be placed into different positions throughout the inside of the IRDS 1540 for different projection angles.

In some embodiments, the top of the IRDS 1540 may comprise a circular entryway, wherein light may pass through to the mirrors. In some aspects, the circular entryway may help concentrate the light passage, whereby a brighter picture may be projected. In some implementations, the mirrors on the interior may help with image correction when light passes through the IRDS 1540. In some embodiments, the mirrors may be removed through the bottom of the IRDS 1540. In some implementations, the bottom of the IRDS 1540 may comprise a larger opening, whereby the light may be projected.

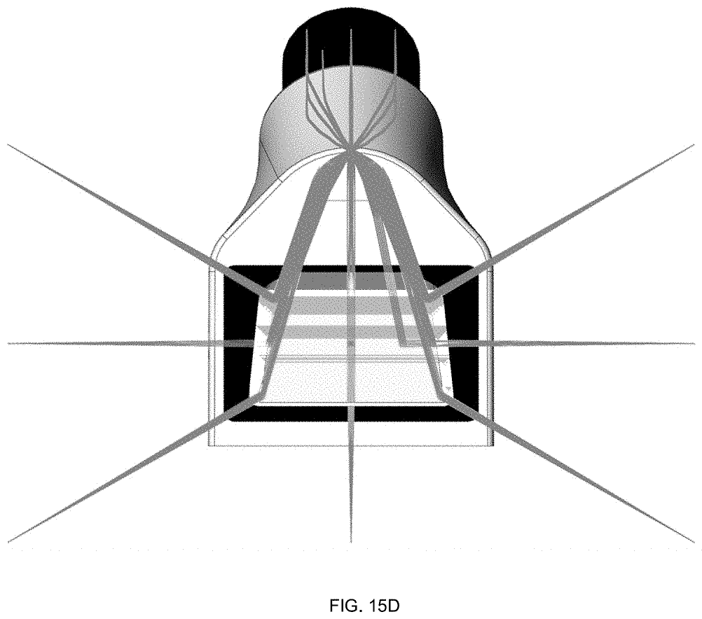

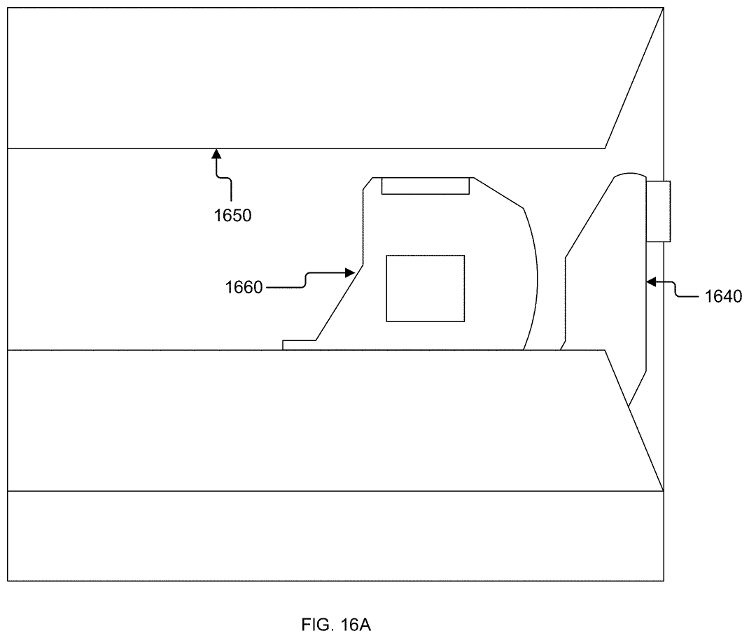

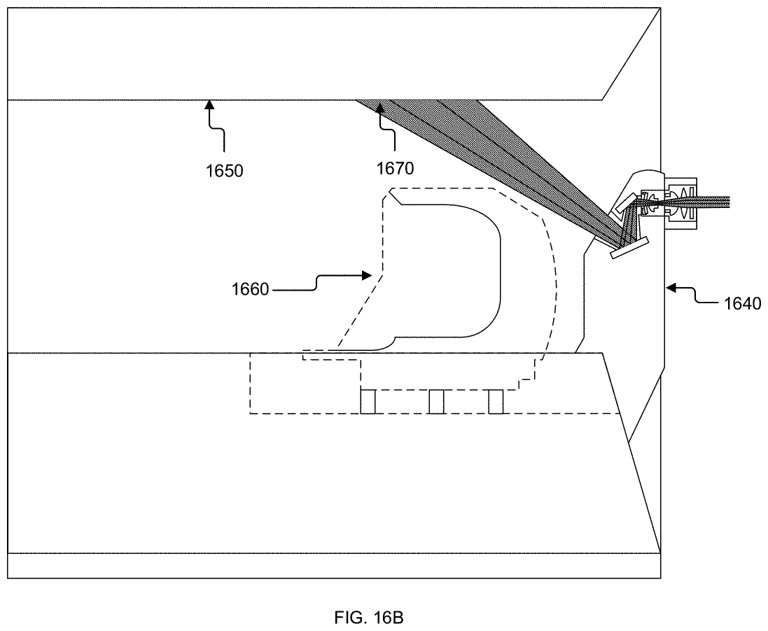

Referring now to FIG. 16A, an exemplary image relay and deflection subsystem 1640 and a projection surface 1650 is illustrated. In some implementations, the projection surface 1650 may comprise an IRDS 1640, wherein the IRDS 1640 is attached to the projection surface 1650. In some aspects, the IRDS 1640 may be removed from the projection surface 1650. For example, the projection surface 1650 may comprise a locking mechanism, wherein the IRDS 1640 may be temporarily attached to the projection surface 1650. In some embodiments, the locking mechanism may comprise edges on the IRDS 1640 and projection surface 1650 that interlock.

In some aspects, the positioning apparatus 1660 may be removed from the projection surface 1650. In some implementations, the IRDS 1640 may comprise a mechanism, wherein the device may be attached to the position apparatus 1660. In some embodiments, the positioning apparatus 1660 may comprise a movement system that allows it to be slid horizontally inside the projection surface 1650. In some implementations, the IRDS 1640 may move with the positioning apparatus 1660 when attached. In some aspects, the remotely projected image from the IRDS 1640 may move along the projection surface 1650 when in motion. For example, the positioning apparatus 1660 and IRDS 1640 may slide horizontally within the projection surface 1650 and the projected image may move along the projection surface 1650.

Referring now to FIG. 16B, an exemplary image relay and deflection subsystem (IRDS) 1640 and a projection surface 1650 is illustrated. In some implementations, the surface at the center of the RPI 1670 may be ninety degrees to the IRDS 1640. In some embodiments, the IRDS 1640 may project the image between zero and seventy degrees onto the projection surface 1650. In some implementations, the IRDS 1640 may use image correction to project a clear and precise image onto the projection surface 1650.

In some embodiments, the projection surface 1650 may comprise an uneven area. For example, the surface area of the projection surface 1650 may comprise an upward curving surface, and the IRDS 1640 may project the image without distortion. In some embodiments, the projection surface 1650 may be located proximate to a positioning apparatus 1660, wherein the placement does not affect the projected image from the IRDS 1640. For example, the positioning apparatus may maintain a position of a patient within an MM machine. In some embodiments, the positioning apparatus 1660 may shift horizontally without affecting the image of projected from the IRDS 2340.

Referring now to FIG. 17A, an exemplary remote image projection system 1700 and a projection surface 1750 is illustrated. In some embodiments, the projection surface 1750 may comprise a peaked center of the interior of a tent or a curved side of a tent. For example, the IRDS 1740 may project a flat corrected image on to the peak of a camping tent. In some implementations, the remote image projection system 1700 may comprise an expanding mirror, wherein the projected image may be altered in width and height. In some implementations, the IRDS 1740 may comprise a series of mirrors, wherein the projected image from the remote image projection system 1700 may be corrected when projected to the projection surface 1750.

Referring now to FIG. 17B, an exemplary remote image projection system 1700 and a projection surface 1751 is illustrated. In some embodiments, the projection surface 1751 may comprise a peaked center of the exterior of a tent or a curved side of a tent. In some implementations, the ICS may provide correction for optical distortions resulting from the oblique angle of incidence on the projection surface 1751, particularly those which are not planar.

In some aspects, the ICS may produce a warped projection that provides an undistorted image on a nonplanar surface. In some embodiments, the ICS may utilize external sensors and a coded image to tessellate the contours of the nonplanar projection surface 1751. In some implementations, the dewarping algorithm may use machine learning to recursively refine the dewarping algorithm until the resulting warped projection is within the predetermined parameters of the RIPS.

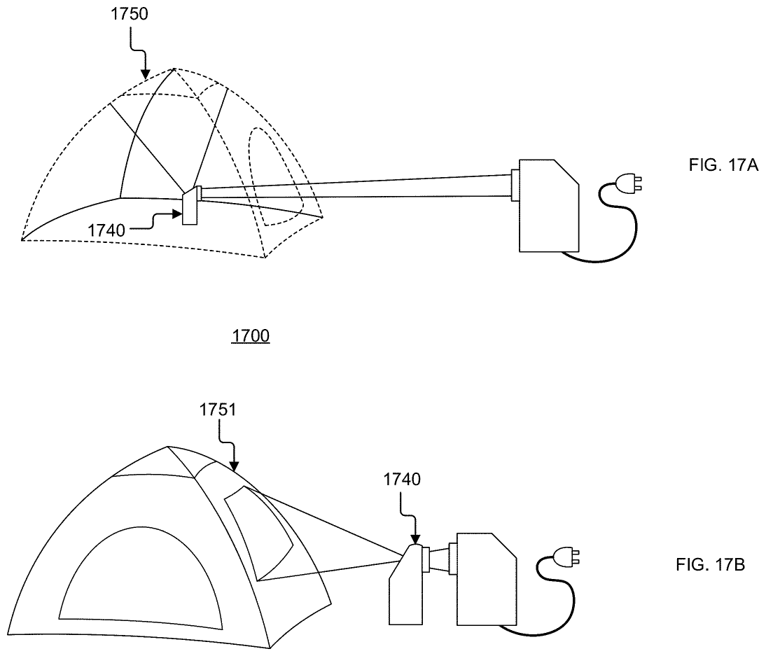

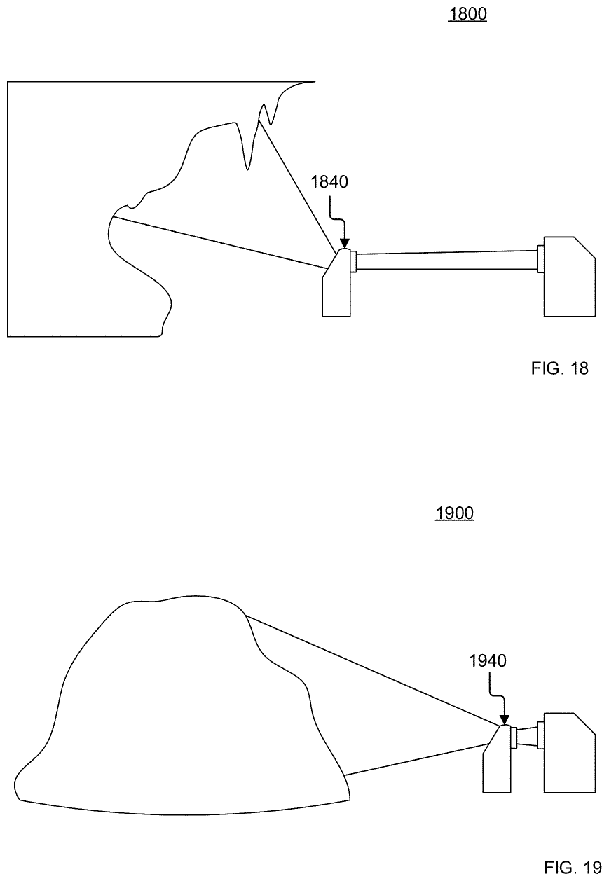

Referring now to FIG. 18, an exemplary remote image projection system 1800 and a projection surface is illustrated. In some embodiments, the projection surface may comprise a plurality of contours. For example, a cave wall or concave rock face may be used as a projection surface to display a map for a group of hikers on an outdoors trail. In some implementations, the IRDS 1840 may comprise components that allow for autonomous adjustment of the projection angle.

In some implementations, the ICS may provide correction for optical distortions resulting from the oblique angle of incidence on the projection surface, particularly those which are not planar. In some aspects, the ICS may produce a warped projection that provides an undistorted image on a nonplanar surface. In some embodiments, the ICS may utilize external sensors and a coded image to tessellate the contours of the nonplanar projection surface. In some implementations, the dewarping algorithm may use machine learning to recursively refine the dewarping algorithm until the resulting warped projection is within the predetermined parameters of the RIPS.

Referring now to FIG. 19, an exemplary remote image projection system 1900 and a projection surface 1950 is illustrated. In some implementations the remote image projection system 1900 may be positioned in the line of sight of the projection surface 1950. In some embodiments, the image projected from the remote image projection system 1900 may contour to the projection surface 1950. In some implementations, the IRDS 1940 may be positioned in different locations to aid with image projection. For example, the IRDS 1940 may be positioned in a different location from the remote image projection system 1900 based on the needs of the user.

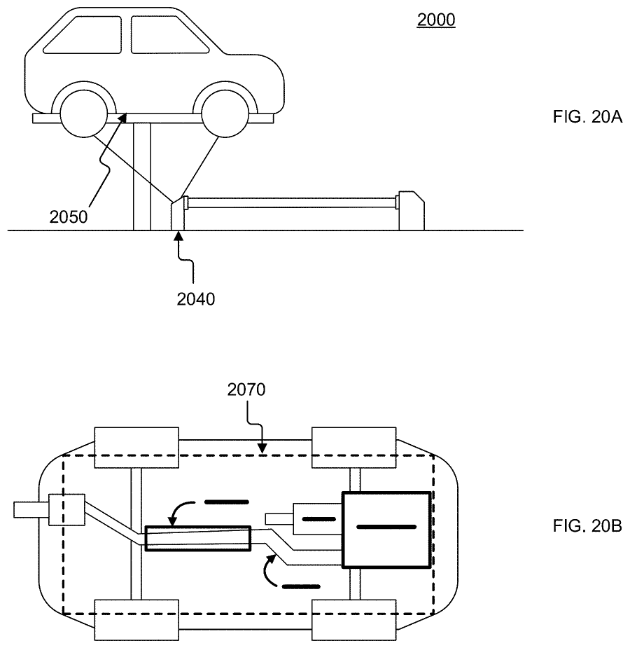

Referring now to FIGS. 20A-20B, an exemplary remote image projection system 2000 and a projection surface 2050 is illustrated. In some implementations, the IRDS 2040 may comprise a mirror that projects the image upward onto the projection surface 2050.

In some aspects, the remote projection system 2000 may comprise a plurality of components, wherein the components may be taken apart and placed into a travel device. In some embodiments, the projection surface 2050 may be a vehicle that the remote image projection system 2000 may project an image on. For example, the remote image projection image 2000 may project an image on the underside of an automobile on a lift, such as for training purposes.

In some implementations, the ICS may provide correction for optical distortions resulting from the oblique angle of incidence on the projection surface 2050, particularly those which are not planar. In some aspects, the ICS may produce a warped projection that provides an undistorted RPI 2070 on a nonplanar surface. In some embodiments, the ICS may utilize external sensors and a coded image to tessellate the contours of the nonplanar projection surface 2050. In some implementations, the dewarping algorithm may use machine learning to recursively refine the dewarping algorithm until the resulting warped projection is within the predetermined parameters of the RIPS.

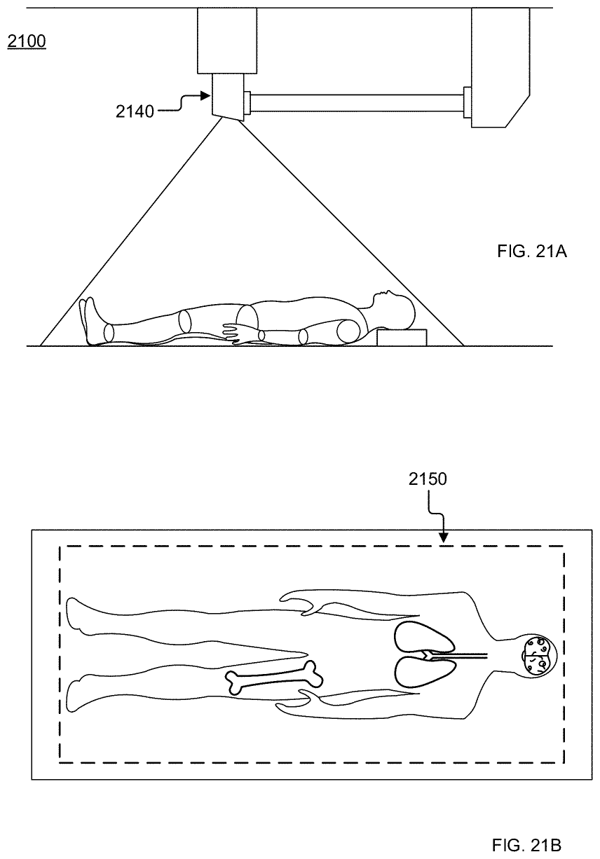

Referring now to FIGS. 21A-21B, an exemplary remote image projection system 2100 and a projection surface 2150 is illustrated. In some embodiments, the projection surface 2150 may comprise a human silhouette, wherein the IRDS 2140 may project an image directly onto the projection surface 2150. For example, if an incision line needed to be made, the IRDS 2140 may project an image depicting the incision line and where it may need to be located.

In some aspects, the remote image projection system 2100 may cycle through different images. In some embodiments, the remote image projection system 2100 may comprise a mechanism, wherein the image projection changes when activated. For example, the first image may comprise incisions throughout the projection surface 2150, whereas the second image may comprise suture diagrams. In some implementations, the remote image projection system 2100 may project a larger image that fits the projection surface 2150.

In some embodiments, the ICS may utilize external sensors and a coded image to tessellate the contours of the nonplanar projection surface. In some implementations, the dewarping algorithm may use machine learning to recursively refine the dewarping algorithm until the resulting warped projection is within the predetermined parameters of the RIPS.

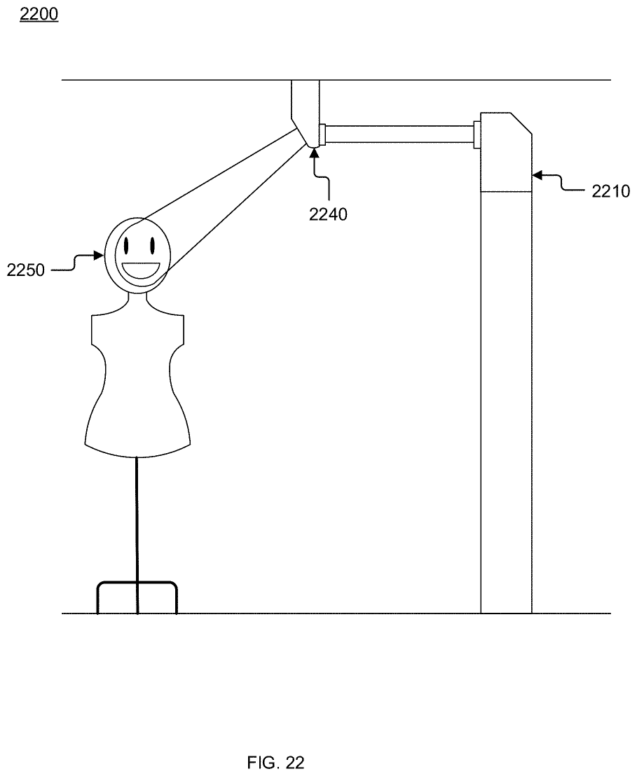

Referring now to FIG. 22, an exemplary remote image projection system 2200 and a projection surface 2250 is illustrated. In some aspects, the IRDS 2240 may project an image in a downward angle toward the projection surface 2250. For example, the projection surface 2250 may be on wheels, and be moved around on demand, such as for a display mannequin in a store. In some embodiments, the remote image projection system 2200 may comprise a sensing mechanism, wherein the image projected may mimic the movement of the projection surface 2250. In some aspects, the projection subsystem 2210 may comprise an adjustable height mechanism, wherein the height of the projection subsystem 2210 may be adjusted to the line of sight of the projection surface 2250.

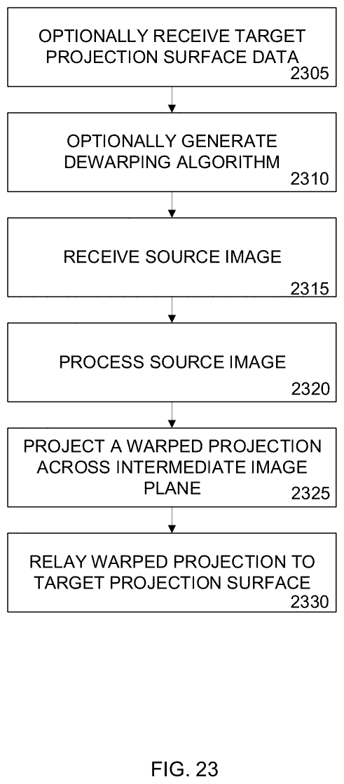

Referring now to FIG. 23, exemplary method steps for projecting a remote image are illustrated. In some implementations, at 2305, target projection surface data may be received. In some aspects, at 2310, a dewarping algorithm may be generated. In some embodiments, the dewarping algorithm may be generated according to the process outlined in the descriptions of FIG. 12. In some implementations, the dewarping algorithm may generate correlated data points between the source image and the remotely projected image.

At 2315, a source image may be received. At 2320, a source image may be processed. In some embodiments, the source image may be processed via interpolation of tessellated points. At 2325, a warped projection across intermediate image plane may be projected. At 2330, a warped projection may be relayed to a target projection surface.

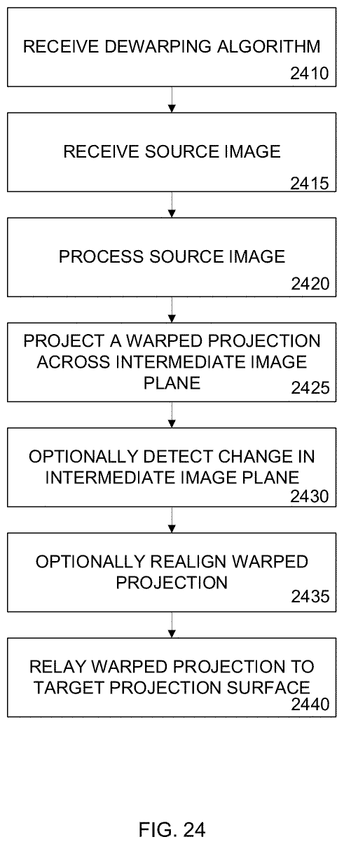

Referring now to FIG. 24, exemplary method steps for projecting a remote image are illustrated. At 2410, a dewarping algorithm may be received. At 2415, a source image may be received. At 2420, a source image may be processed. At 2425, a warped projection across an intermediate image plane may be projected. At 2430, a change in intermediate image plane may be detected. At 2435, a warped projection may be realigned. At 2440, warped projection may be relayed to a target projection surface.

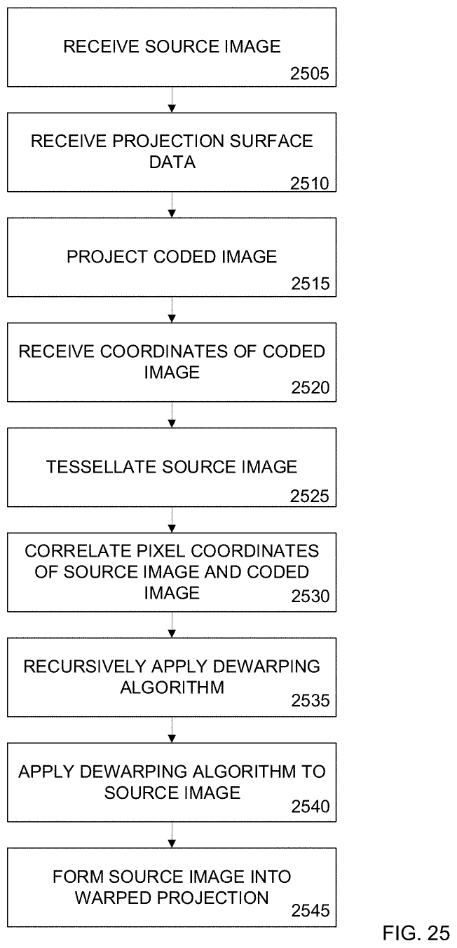

Referring now to FIG. 25, exemplary method steps for interpolating a source image are illustrated. At 2505, a source image may be received. At 2510, target projection surface data may be received. At 2515, a coded image may be projected. At 2520, coordinates from a coded image may be received. At 2525, a dewarping algorithm may tessellate the source image. In some aspects, processing may comprise transformation of coefficients relating the source image coordinates to the warped projection coordinates. At 2530, a dewarping algorithm may correlate pixel coordinates of the source image and the coded image. In some embodiments, processing may comprise transformation coefficients correlating source image pixel locations to warped projection pixel locations. At 2535, a dewarping algorithm may be recursively applied such as through machine learning until predetermined parameters are satisfied. At 2540, a dewarping algorithm may be applied to the source image. At 2545, a source image may be formed into a warped projection.

### CONCLUSION

A number of embodiments of the present disclosure have been described. While this specification contains many specific implementation details, these should not be construed as limitations on the scope of any disclosures or of what may be claimed, but rather as descriptions of features specific to particular embodiments of the present disclosure.

Certain features that are described in this specification in the context of separate embodiments can also be implemented in combination or in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described program components and systems can generally be integrated together in a single software product or packaged into multiple software products.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. Other embodiments of this aspect include corresponding computer systems, apparatus, and computer programs recorded on one or more computer storage devices, each configured to perform the actions of the methods.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

What is claimed is:

1. A system for remote image projection, the system comprising:
an image correction subsystem comprising a dewarping algorithm, wherein the image correction subsystem is configured to receive a source image, and wherein application of the source image to the dewarping algorithm transmits a warped image based on predefined parameters of a target projection surface;
a projection subsystem comprising:
a light engine in logical communication with the image correction subsystem, wherein the light engine transmits a warped projection from the warped image,
a projection optics, wherein the warped projection is formed to a predetermined size, and an intermediate image is created at a remote distance from the projection subsystem; and
an image relay and deflection subsystem configured to receive the warped projection from the projection subsystem, wherein the warped projection is transmitted through an intermediate image plane, and wherein the image relay and deflection subsystem comprises:
a relay optics, wherein the projection is focused and scaled to a predefined size, and
a first fold mirror group configured to adjust an angle of the warped projection and project the warped projection onto the target projection surface, wherein projection of the warped projection on the target projection surface creates a remotely projected image.

2. The system of claim 1, wherein at least a portion of one or both the projection subsystem or the image relay and deflection system are movable, and wherein the intermediate image plane position is variable.

3. The system of claim 2, further comprising an image motion and positioning subsystem, wherein the light engine is adjustable to the intermediate image plane.

4. The system of claim 1, wherein the image relay and deflection system comprise materials benign to operation in a high strength magnetic field.

5. The system of claim 1, wherein the projection subsystem is vertically oriented and the warped projection is projected horizontally with use of a second fold mirror group to the image relay and deflection subsystem.

6. The system of claim 1, wherein the target projection surface is nonplanar.

7. The system of claim 1, wherein the image correction subsystem is further configured to generate the dewarping algorithm.

8. A method for projecting remote images, the method comprising:
receiving a source image;
processing the source image with a dewarping algorithm, wherein the dewarping algorithm warps the source image based on predefined parameters of a target projection surface; and
projecting a warped image into a warped projection to an intermediate image plane in proximity to an image relay and deflection subsystem, wherein projected warped projection at the intermediate image plane is projected onto the target projection surface by an image relay and deflection subsystem.

9. The method of claim 8, wherein the processing comprises transformation coefficients relating the source image coordinates to the warped projection coordinates.

10. The method of claim 8, wherein the processing comprises transformation coefficients correlating source image pixel locations to warped projection pixel locations.

11. The method of claim 8, wherein the target projection surface comprises a nonplanar surface geometry.

12. The method of claim 8, wherein the target projection surface comprises an irregular surface geometry.

13. The method of claim 8, wherein projecting the warped projection in free space to the intermediate image plane occurs from a light source through a projection optics.

14. The method of claim 8, wherein the image relay and deflection subsystem comprises a relay optics and a second fold mirror group.

15. The method of claim 8, further comprising aligning the warped projection with the image relay and deflection subsystem.

16. The method of claim 15, wherein the intermediate image plane is variable distances.

17. The method of claim 16, wherein the projecting is constant across variable distances.

18. The method of claim 8, further comprising generating the dewarping algorithm.

19. The method of claim 18, further comprising receiving predefined parameters of the target projection surface.

20. The method of claim 18, further comprising generating predefined parameters of the target projection surface.
